(19) United States
(12) Patent Application Publication
(10) Pub. No.: US 2025/0100555 A1
(43) Pub. Date: Mar. 27, 2025

(54) APPARATUS AND METHOD FOR DYNAMIC DETERMINATION OF SAFETY DISTANCE BETWEEN VEHICLES

(71) Applicant: HERE GLOBAL B.V., Eindhoven (NL)

(72) Inventors: Jerome BEAUREPAIRE, Courbevoie (FR); Amarnath NAYAK, Borivali East (IN)

(73) Assignee: HERE GLOBAL B.V., EINDHOVEN (NL)

(21) Appl. No.: 18/371,398

(22) Filed: Sep. 21, 2023

(51) Int. Cl. B60W 30/16; G06N 20/00; G07C 5/00

(52) U.S. Cl. CPC B60W 30/16; G06N 20/00; G07C 5/004; B60W 2552/10; B60W 2554/40; B60W 2554/4045; B60W 2554/802; B60W 2556/40; B60W 2556/65; B60W 2754/30

(57) ABSTRACT

A system for dynamic determination of safety distance between vehicles is disclosed. The apparatus retrieves a first safety distance between a subject vehicle and a preceding vehicle of a set of vehicles within a first pre-determined distance of the subject vehicle. The preceding vehicle is traveling directly ahead of the subject vehicle. The apparatus further obtains a set of features associated with one or more of the set of vehicles, one or more of a set of users driving the set of vehicles, or a combination thereof. The apparatus further determines a second safety distance to be maintained between the subject vehicle and the preceding vehicle based on the first safety distance and the set of features. The second safety distance is less than the first safety distance. The apparatus further outputs the determined second safety distance on a user interface.

### TECHNOLOGICAL FIELD

The present disclosure generally relates to determining safety distance between vehicles, and more particularly relates to an apparatus and a method for dynamic determination of safety distance between vehicles.

### BACKGROUND

With advancements in the field of automotive engineering and with a decrease in the cost of acquisition of vehicles, there is a continuous rise in a number of vehicles traversing a road network. While driving on the roads, multiple safety guidelines need to be followed by drivers of the vehicles for their safety and the safety of other drivers whose vehicles are traversing the roads. Such safety guidelines include, but are not limited to, maintaining a safety distance from other vehicles, giving an indicator while changing lanes, wearing a seat belt, obeying traffic signals and speed limits, avoiding distractions, such as using your cellphone or eating while driving, and checking and maintaining vehicle regularly. The drivers of the vehicles are required to have knowledge about the above-mentioned safety guidelines before they are granted a driving license. Furthermore, some of the safety guidelines, such as maintaining a safety distance or giving an indicator while changing lanes, may need to be followed even by autonomous vehicles. However, despite teaching such safety guidelines through various channels, the number of vehicle-related accidents is rising particularly due to mistakes made by the drivers while driving the vehicles or due to technical failures of the autonomous vehicles.

One of the above safety guidelines is to maintain a safety distance between vehicles. This safety guideline indicates that a vehicle must maintain a safe distance from a preceding vehicle to allow a driver of the vehicle enough time to react if the preceding vehicle suddenly stops or slows down. Usually, drivers are required to follow a two-second rule to maintain such safety distance. The two-second rule is a rule of thumb by which a driver may maintain a safe trailing distance at any speed. The rule indicates that a driver should ideally stay at least two seconds behind any vehicle that is directly in front of his or her vehicle. It may be noted that the two-second rule may also need to be followed by autonomous vehicles to provide sufficient time for autonomous vehicles to react to behaviors of preceding vehicles. However, many drivers face situations in which an interfering vehicle maneuvers to occupy a safety distance maintained between a vehicle and a preceding vehicle. Such situations might lead to accidents and may be dangerous to the drivers of the vehicles.

Therefore, there is a need for determining a safety distance between a vehicle and a preceding vehicle in an optimum manner to avoid the situations that may lead to accidents.

### BRIEF SUMMARY OF SOME EXAMPLE EMBODIMENTS

An apparatus, a method, and a computer programmable product are provided for implementing the process for dynamic determination of safety distance between vehicles. In one aspect, an apparatus for dynamic determination of safety distance between vehicles is disclosed. The apparatus includes at least one processor and at least one non-transitory memory including computer program code instructions, the computer program code instructions configured to, when executed, cause the apparatus to: retrieve a first safety distance between a subject vehicle and a preceding vehicle among a set of vehicles within a pre-determined distance of the subject vehicle, wherein the preceding vehicle is traveling directly ahead of the subject vehicle; obtain a set of features associated with one or more of the set of vehicles, one or more of a set of users driving the set of vehicles, or a combination thereof; determine a second safety distance to be maintained between the subject vehicle and the preceding vehicle based on the first safety distance and the set of features, wherein the second safety distance is less than the first safety distance; and output the second safety distance on a user interface.

In additional apparatus embodiments, to determine the second safety distance, the computer program code instructions are configured to, when executed, cause the apparatus to: monitor a trigger event indicative of a change in a value of at least one feature associated with the set of vehicles or the set of users; and responsive to detecting the trigger event, determine the second safety distance.

In additional apparatus embodiments, the set of features is a second set of features, and the computer program code instructions are configured to, when executed, cause the apparatus to: obtain a first set of features associated with: (i) information associated with the subject vehicle; (ii) vehicle information associated with the one or more of the set of vehicles; (iii) road information associated with a road on which the subject vehicle and the set of vehicles are being driven; (iv) traffic information associated with the road; (v) environmental information; (vi) distance information associated with a distance between the subject vehicle and a first lane of a set of lanes on the road; (vii) temporal information; or (viii) a combination thereof; determine the first safety distance to be maintained between the subject vehicle and the preceding vehicle based on the first set of features; and output the first safety distance on the user interface.

In additional apparatus embodiments, to determine the first safety distance, the computer program code instructions are configured to, when executed, cause the apparatus to: apply a machine learning (ML) model on the first set of features, wherein the ML model is trained to output the first safety distance based on the first set of features; and determine the first safety distance based on the output of the ML model.

In additional apparatus embodiments, the set of features is associated with: (i) vehicle information associated with the one or more of the set of vehicles; (ii) driving information associated with the one or more of the set of vehicles; (iii) traffic information associated with a road on which the subject vehicle and the set of vehicles are being driven; (iv) user information associated with the one or more of the set of users; (v) temporal information; (vi) distance information indicating a distance between two vehicles of the set of vehicles; or (vii) a combination thereof.

In additional apparatus embodiments, to determine the second safety distance, the computer program code instructions are configured to, when executed, cause the apparatus to: apply a machine learning (ML) model on the set of features, wherein the ML model is trained to output the second safety distance based on the set of features; determine the second safety distance based on the output of the ML model, wherein the second safety distance is indicative of a gap to be maintained between the subject vehicle and the preceding vehicle, and wherein the second distance is a distance to be maintained between the subject vehicle and the preceding vehicle to avoid an occupation of the gap by at least one vehicle of the set of vehicles.

In additional apparatus embodiments, the computer program code instructions are configured to, when executed, cause the apparatus to: receive a user input associated with a determination of a navigation route from a first location to a second location; determine, from a map database, a set of navigation routes from the first location to the second location based on the received user input, wherein each navigation route of the set of navigation routes comprises information indicating the first safety distance, the second safety distance, or a combination thereof; select a first navigation route from the determined set of navigation routes; and output the selected first navigation route on the user interface.

In additional apparatus embodiments, to obtain the set of features, the computer program code instructions are configured to, when executed, cause the apparatus to: transmit a command to a map database, wherein the command is associated with retrieval of at least one feature of the set of features from the map database; and obtain the at least one feature of the set of features from the map database.

In additional apparatus embodiments, to obtain the set of features, the computer program code instructions are configured to, when executed, cause the apparatus to: receive sensor data from one or more sensors of the subject vehicle, one or more sensors of the set of vehicles, or a combination thereof; and obtain at least one of the set of features from the sensor data.

In additional apparatus embodiments, the subject vehicle is an electric vehicle, and the computer program code instructions are configured to, when executed, cause the apparatus to: compute a driving range of the subject vehicle based on the first safety distance, the second safety distance, or a combination thereof; and output the computed driving range of the subject vehicle on the user interface.

In additional apparatus embodiments, the computer program code instructions are configured to, when executed, cause the apparatus to: generate a virtual object indicating the first safety distance, the second safety distance, or a combination thereof; and output the virtual object on an infotainment system of the subject vehicle.

In additional apparatus embodiments, the computer program code instructions are configured to, when executed, cause the apparatus to: transmit the first safety distance, the second safety distance, or a combination thereof to the one or more of the set of vehicles; and receive at least one notification from the one or more of the set of vehicles, wherein the at least one notification is associated with an overtaking of the subject vehicle by the one or more of the set of vehicles.

In additional apparatus embodiments, the computer program code instructions are configured to, when executed, cause the apparatus to: calculate a likelihood value indicative of a likelihood of the one or more of the set of vehicles overtaking the subject vehicle and occupying a gap between the subject vehicle and the preceding vehicle; and output the likelihood value on the user interface.

In additional apparatus embodiments, the computer program code instructions are configured to, when executed, cause the apparatus to control maneuver of the subject vehicle to maintain the first safety distance or the second safety distance.

In another aspect, a method of providing a safety distance between a subject vehicle and a preceding vehicle is disclosed. The method includes retrieving a first safety distance between the subject vehicle and a preceding vehicle among a set of vehicles within a pre-determined distance of the subject vehicle, wherein the preceding vehicle is traveling directly ahead of the subject vehicle; obtaining a set of features associated with one or more of the set of vehicles, one or more of a set of users driving the set of vehicles, or a combination thereof; determining a second safety distance to be maintained between the subject vehicle and the preceding vehicle based on the first safety distance and the set of features, wherein the second safety distance is less than the first safety distance; and outputting the second safety distance on a user interface.

In additional method embodiments, the method includes applying a first machine learning (ML) model on a first set of features, wherein the first ML model is trained to output the first safety distance based on the first set of features, and wherein the first set of features are associated with: (i) information associated with the subject vehicle; (ii) vehicle information associated with the one or more of the set of vehicles; (iii) road information associated with a road on which the subject vehicle and the set of vehicles are being driven; (iv) traffic information associated with the road; (v) environmental information; (vi) distance information associated with a distance between the subject vehicle and a first lane of a set of lanes on the road; (vii) temporal information; or (viii) a combination thereof; and determining the first safety distance based on an output of the first ML model.

In additional method embodiments, the determining the second safety distance comprises: applying a second machine learning (ML) model on the set of features, wherein the set of features is a second set of features; determining the second safety distance based on an output of the second ML model. The second safety distance is indicative of a gap to be maintained between the subject vehicle and the preceding vehicle, and the second distance is a distance to be maintained between the subject vehicle and the preceding vehicle to avoid an occupation of the gap by at least one vehicle of the set of vehicles.

In yet another aspect, a non-transitory computer-readable storage medium having computer program code instructions stored therein is described. The computer program code instructions, when executed by at least one processor, cause the at least one processor to: retrieve a first safety distance between a subject vehicle and a preceding vehicle among a set of vehicles within a pre-determined distance of the subject vehicle, wherein the preceding vehicle is traveling directly ahead of the subject vehicle; obtain a set of features associated with one or more of the set of vehicles, one or more of a set of users driving the set of vehicles, or a combination thereof; determine a second safety distance to be maintained between the subject vehicle and the preceding vehicle based on the first safety distance and the set of features, wherein the second safety distance is less than the first safety distance; and output the second safety distance on a user interface.

In additional non-transitory computer-readable storage medium embodiments, the computer program code instructions, when executed by the at least one processor, cause the at least one processor to: apply a first machine learning (ML) model on a first set of features, wherein the first ML model is trained to output the first safety distance based on the first set of features, and wherein the first set of features are associated with: (i) information associated with the subject vehicle; (ii) vehicle information associated with the one or more of the set of vehicles; (iii) road information associated with a road on which the subject vehicle and the set of vehicles are being driven; (iv) traffic information associated with the road; (v) environmental information; (vi) distance information associated with a distance between the subject vehicle and a first lane of a set of lanes on the road; (vii) temporal information; or (viii) a combination thereof; and determine the first safety distance based on an output of the first ML model.

In additional non-transitory computer-readable storage medium embodiments, to determine the second safety distance, the computer program code instructions, when executed by the at least one processor, cause the at least one processor to: apply a second machine learning (ML) model on the set of features, wherein the set of features is a second set of features; determine the second safety distance based on an output of the second ML model. The second safety distance is indicative of a gap to be maintained between the subject vehicle and the preceding vehicle, and the second distance is a distance to be maintained between the subject vehicle and the preceding vehicle to avoid an occupation of the gap by at least one vehicle of the set of vehicles.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment for dynamic determination of a safety distance between vehicles, in accordance with an embodiment of the disclosure;

FIG. 2 illustrates a block diagram of the apparatus of FIG. 1, in accordance with an embodiment of the disclosure;

FIG. 3 is a diagram that illustrates exemplary operations for determining safety distance between vehicles, in accordance with an embodiment of the disclosure;

FIGS. 4A and 4B are diagrams that collectively depict an exemplary scenario for dynamic adjustment of a safety distance between vehicles, in accordance with an embodiment of the disclosure;

FIG. 5 is a diagram that illustrates an exemplary scenario for depicting a safety distance between vehicles;

FIG. 6A is a diagram that illustrates training of a first ML model of a set of machine learning (ML) models for determining a first safety distance between vehicles, in accordance with an embodiment of the disclosure;

FIG. 6B is a diagram that illustrates training of a second ML model of the set of machine learning (ML) models for determining a second safety distance between vehicles, in accordance with an embodiment of the disclosure;

FIG. 7 is a flowchart that illustrates an exemplary method for dynamic determination of a safety distance between vehicles based on a trigger event, in accordance with an embodiment of the disclosure; and

FIG. 8 is a flowchart that illustrates an exemplary method for determination of a second safety distance while maintaining a first safety distance between the vehicles, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

The present disclosure may provide an apparatus, a method, and a computer programmable product for determining a dynamic safety distance between vehicles. The disclosed apparatus and the method provide techniques for determining a minimum safety distance to be maintained between vehicles such that a gap between the vehicles cannot be occupied by surrounding vehicles. The techniques disclosed in the present disclosure may use a set of machine learning models to determine the safety distance to be maintained between the vehicles. The machine learning models may determine the safety distance between the vehicles based on a set of factors associated with surrounding vehicles, road conditions, weather conditions, and the like. Further, the set of machine learning models may be able to dynamically adjust the safety distance between vehicles. Specifically, the set of machine learning models may output a first safety distance and a second safety distance to be maintained between the vehicles. The first safety distance may be indicative of a first gap between the vehicles that can be occupied by any other vehicle, whereas the second safety distance may be indicative of a second gap between the vehicles that may not be occupied by any other vehicle. The disclosed apparatus may dynamically adjust between the first safety distance and the second safety distance based on various parameters related to surrounding vehicles. The dynamic adjustment of the safety distance may be done to avoid occupation of the gap by another vehicle and hence, decrease the probability of collision, thereby increasing the safety of the vehicles and drivers (and co-passengers)

The disclosed apparatus may further communicate with a map database to update the safety distances on a particular road in real-time to inform other users about a behavior (such as driving behavior) of the vehicles plying on the road. The disclosed apparatus and method may be able to predict a near-accurate driving range of electric vehicles based on the determined safety distance. Specifically, the disclosed apparatus may compute the driving range while maintaining the first safety distance or the second safety distance. This may ensure that the computed driving range is close to an actual driving range (or accurate driving range) of the electric vehicle while travelling on the road. Moreover, the disclosed apparatus and method may be configured to alert the driver of the vehicle about the safety distance, visually using augmented reality and audio alerts. This way, the driver may be aware of the safety distance to be maintained between the driver's vehicle and a preceding vehicle. The apparatus and method may also communicate with other vehicles to inform said vehicles about the safety distance between a vehicle and a preceding vehicle. Also, the disclosed apparatus may communicate with a cruise control system of the vehicle to automatically maintain the safety distance.

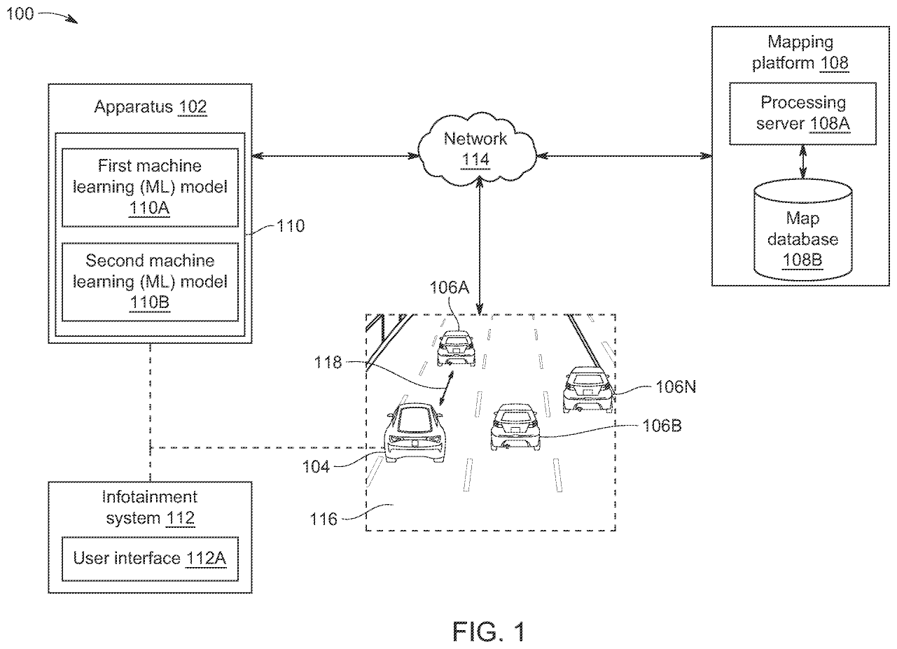

FIG. 1 is a diagram that illustrates a network environment 100 for dynamic determination of safety distance between vehicles, in accordance with an embodiment of the disclosure. With reference to FIG. 1, there is shown a diagram of the network environment 100. The network environment 100 includes an apparatus 102, a subject vehicle 104, a set of vehicles 106, and a mapping platform 108. Apparatus 102 may include a set of machine learning (ML) models 110. The set of ML models may include a first ML model 110A, and a second ML model 110B. The set of vehicles 106 may include a preceding vehicle 106A, a first vehicle 106B, and up to an Nth vehicle 106N. The preceding vehicle 106A may be traveling directly ahead of the subject vehicle 104. The mapping platform 108 may include a processing server 108A and a map database 108B. The network environment 100 may further include an infotainment system 112, and a network 114. The infotainment system 112 may include a user interface (UI) 112A. The subject vehicle 104 and the set of vehicles 106 may be traveling on a road 116. In one embodiment, apparatus 102 may be associated with the subject vehicle 104. In another embodiment, apparatus 102 may be integrated within the subject vehicle 104. In another embodiment, apparatus 102, the infotainment system 112, or a combination thereof may be integrated within the subject vehicle 104.

Apparatus 102 may include suitable logic, circuitry, interfaces, and/or code that may be configured to determine a set of safety distances (such as a first safety distance, and a second safety distance 118) to be maintained between the subject vehicle 104 and the preceding vehicle 106A among the set of vehicles 106. Specifically, apparatus 102 may be configured to determine the second safety distance 118 based on a set of features. Examples of the electronic device 102 may include, but are not limited to, an electronic control unit (ECU), an electronic control module (ECM), a computing device, a mobile device, a mainframe machine, a server, a computer workstation, any and/or any other device with safety distance determination operations.

In an example embodiment, apparatus 102 may be onboard the subject vehicle 104, such as apparatus 102 may be a safety distance determination system installed in the subject vehicle 104 for determining the safety distance. In another example embodiment, apparatus 102 may be the processing server 108A of the mapping platform 108 and therefore may be co-located with or within the mapping platform 108.

In another embodiment, apparatus 102 may be embodied as a cloud-based service, a cloud-based application, a cloud-based platform, a remote server-based service, a remote server-based application, a remote server-based platform, or a virtual computing system. In yet another example embodiment, apparatus 102 may be an OEM (Original Equipment Manufacturer) cloud. The OEM cloud may be configured to anonymize any data received by apparatus 102, such as from the set of features, before using the data for further processing, such as before sending the data to the set of ML models 110 (or to the map database 108B). For an example, anonymization of the data may be done by the mapping platform 108.

The subject vehicle 104 and each of the set of vehicles 106 may be a non-autonomous vehicle, a semi-autonomous vehicle, or a fully autonomous vehicle, for example, as defined by National Highway Traffic Safety Administration (NHTSA). Examples of the subject vehicle 104 and each of the set of vehicles 106 may include, but are not limited to, a two-wheeler vehicle, a three-wheeler vehicle, a four-wheeler vehicle, more than four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The subject vehicle 104 and each of the set of vehicles 106 may be a system through which an occupant (for example a rider) may travel from a start point to a destination point. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell-based car, a solar powered-car, or a hybrid car. It may be noted here that the four-wheeler diagram of the subject vehicle 104 and each of the set of vehicles 106 are merely shown as examples in FIG. 1. The present disclosure may also be applicable to other structures, designs, or shapes of the subject vehicle 104 and each of the set of vehicles 106. The description of other types of the vehicle and respective structures, designs, or shapes has been omitted from the disclosure for the sake of brevity.

In some example embodiments, the subject vehicle 104 and each of the set of vehicles 106 may include processing means such as a central processing unit (CPU), storage means such as on-board read-only memory (ROM), and random access memory (RAM), acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of the subject vehicle 104 and each of the set of vehicles 106. In some example embodiments, user equipment may be associated, coupled, or otherwise integrated with the vehicles 106, such as an advanced driver assistance system (ADAS), a personal navigation device (PND), a portable navigation device, the infotainment system 112, and/or other devices that may be configured to provide route guidance and navigation-related functions to the user.

In some example embodiments, the subject vehicle 104 and each of the set of vehicles 106 may generate sensor data associated with the subject vehicle 104, the set of vehicles 106, lane data, traffic data, and the like. In accordance with an embodiment, the sensor data may be generated by the subject vehicle 104 and each of the set of vehicles 106 when one or more sensors on-board the subject vehicle 104 and/or the set of vehicles 106 sense information relating to, for example, traffic in a vicinity of the vehicles and a road condition, and so forth. In accordance with an embodiment, the subject vehicle 104 or the set of vehicles 106 may generate the sensor data in real-time and transmit the same to apparatus 102 to determine the safety distance. In certain cases, the subject vehicle 104 and each of the set of vehicles 106 may send updated sensor data periodically, for example, every five seconds, every thirty seconds, every minute, and so forth.

In an example, the user equipment may be installed in the subject vehicle 104 and each of the set of vehicles 106 and may be configured to detect sensor data and traffic conditions on link segments and/or road segments by using image-based sensors, i.e., image sources installed in the corresponding vehicle. Alternatively, the image sources may be installed on link segments or roads, and the image sources may detect sensor data and traffic conditions for corresponding location on the links segments or roads. The image sources and/or the user equipment may transmit the detected sensor data and traffic conditions to apparatus 102, which processes the detected data to determine the safety distance.

The mapping platform 108 may comprise suitable logic, circuitry, and interfaces that may be configured to store one or more map attributes and sensor data associated with traffic on link segments and lane segments. The mapping platform 108 may be configured to store and update map data indicating the traffic data along with other map attributes, road attributes, and traffic entities, in the map database 108B. The mapping platform 108 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as chips) that include materials, components and/or wires on a structural assembly (such as a baseboard).

In some example embodiments, the mapping platform 108 may include the processing server 108A for carrying out the processing functions associated with the mapping platform 108 and the map database 108B for storing map data. In an embodiment, the processing server 108A may include one or more processors configured to process requests received from apparatus 102. The processors may fetch sensor data and/or map data from the map database 108B and transmit the same to apparatus 102 in a format suitable for use by apparatus 102.

Continuing further, the map database 108B may comprise suitable logic, circuitry, and interfaces that may be configured to store the sensor data and map data, which may be collected from an image source and/or the subject vehicle 104 and/or the set of vehicles 106 traveling on a lane segment of the road 116, or in a region close to the lane segment. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 108 or the map database 108B of features within an environment that is appropriate for traffic-related services. In accordance with an embodiment, the sensor data may be collected from any sensor that may inform the mapping platform 108 or the map database 108B of features within an environment that is appropriate for mapping. For example, motion sensors, inertia sensors, image capture sensors, proximity sensors, LiDAR sensors, and ultrasonic sensors may be used to collect the sensor data. The gathering of large quantities of crowd-sourced data may facilitate the accurate modeling and mapping of an environment, whether it is a road link or a link within a structure, such as in an interior of a multi-level parking structure.

The map database 108B may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 108B may be configured to receive the map data including the road topology and geometry-related attributes related to the road network from external systems, such as one or more of background batch data services, streaming data services, and third-party service providers, via the network 114.

In accordance with an embodiment, the map data stored in the map database 108B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 108B may further store historical probe data for events (such as, but not limited to, traffic incidents, construction activities, scheduled events, and unscheduled events) associated with Point of Interest (POI) data records or other records of the map database 108B.

For example, the data stored in the map database 108B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 108B in a delivery format to produce one or more compiled navigation databases.

In some embodiments, the map database 108B may be a master geographic database configured on the side of apparatus 102. In accordance with an embodiment, a client-side map database 108B may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the subject vehicle 104) which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 108B.

For an example, the map database 108B may include lane and intersection data records or other data that may represent link in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The map database 108B may additionally include data about places, such as cities, towns, or other communities, and other geographic features such as, but not limited to, bodies of water, and mountain ranges.

In some example embodiments, images received from the image source may be stored within the map database 108B of the mapping platform 108. In certain cases, the mapping platform 108, using the processing server 108A, may suitably process the received images. For example, such processing may include, suitably labeling the images based on corresponding associated lane and/or link, point of interest within the link and/or lane, and other information relating to the respective link and/or lane. Such labeled images may then be stored within the map database 108B as map data.

Each of the set of ML models 110 may be trained to identify a relationship between inputs, such as a set of features in a training dataset and output predictive values. Each of the set of ML models 110 may be defined by its hyper-parameters, for example, a number of weights, cost function, input size, number of layers, and the like. The hyper-parameters of each of the set of ML models 110 may be tuned and weights may be updated to move towards a global minima of a cost function for the corresponding ML model. After several epochs of the training on the feature information in the training dataset, each of the set of ML models 110 may be trained to output a prediction result for a set of inputs. The prediction result may be indicative of the safety distance to be maintained between the subject vehicle 104 and the preceding vehicle 106A of the set of vehicles 106.

Each of the set of ML models 110 may include electronic data, such as, for example, a software program, code of the software program, libraries, applications, scripts, or other logic or instructions for execution by a processing device, such as apparatus 102. Each of the set of ML models 110 may include code and routines configured to enable a computing device, such as apparatus 102 to perform one or more operations for determination of the safety distance to be maintained between the subject vehicle 104, and the preceding vehicle 106A. Specifically, the first ML model 110A of the set of ML models 110 may be trained to output the first safety distance, and the second ML model 110B of the set of ML models 110 may be trained to output the second safety distance. Additionally, or alternatively, each of the set of ML models 110 may be implemented using hardware including a processor, a microprocessor (e.g., to perform or control the performance of one or more operations), a field-programmable gate array (FPGA), or an application-specific integrated circuit (ASIC). Alternatively, in some embodiments, each of the set of ML models 110 may be implemented using a combination of hardware and software. Examples of each of the of the set of ML models 110 may include, but are not limited to, a Deep Neural Network (DNN), an Artificial Neural Network (ANN), Long Short-Term Memory (LSTM) network (ANN-LSTM), a Convolutional Neural Network (CNN), a CNN-Recurrent Neural Network (RNN), a Connectionist Temporal Classification (CTC) model, or a Hidden Markov Model. In some embodiment, the safety apparatus 102 may include only one ML model of the set of ML models 110 to determine the safety distance.

Apparatus 102 may be communicatively coupled to the subject vehicle 104, each of the set of vehicles 106 and the mapping platform 108, via the network 114. In an embodiment, apparatus 102 may be communicatively coupled to other components not shown in FIG. 1 via the network 114. All the components in the network environment 100 may be coupled directly or indirectly to the network 114. The components described in the network environment 100 may be further broken down into more than one component and/or combined together in any suitable arrangement. Further, one or more components may be rearranged, changed, added, and/or removed.

The infotainment system 112 may include suitable logic, circuitry, interfaces and/or code that may be configured to render at least an audio-based data, a video-based data, or the user interface 112A in the subject vehicle 104. The infotainment system 112 may be configured to render the second safety distance 118 (and/or the first safety distance) to be maintained between the subject vehicle 104 and the preceding vehicle 106A on the UI 112A. Examples of the infotainment system 112 may include, but are not limited, an entertainment system, a navigation system, a vehicle user interface (UI) system, an Internet-enabled communication system, and other entertainment systems.

The network 114 may be wired, wireless, or any combination of wired and wireless communication networks, such as cellular, Wi-Fi, internet, local area networks, or the like. In some embodiments, the network 114 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The embodiments disclosed herein address the aforementioned problems relating to determining safety distances between vehicles being driven on the road 116. While driving behind a vehicle, it may be customary to maintain either a short, a medium, or a long safety distance to avoid collision due to unforeseen causes. If the safety distance is large enough, a new vehicle (say the first vehicle 106B) may be tempted to overtake the subject vehicle 104 to fill in the gap between the subject vehicle 104 and the preceding vehicle 106A traveling directly ahead of the subject vehicle 104. This act of overtaking may be unsafe for the subject vehicle 104 as well as the overtaking vehicle (and/or the first vehicle 106B) as it reduces the safety distance of the subject vehicle 104 from the overtaking vehicle (and/or the first vehicle 106B) significantly. It is therefore necessary to maintain the safety distance which not only ensures the optimum safety, but also discourages vehicles from overtaking. To overcome the above-mentioned problems, the aforementioned apparatus 102 is disclosed.

In operation, a user of the subject vehicle 104 may be planning to navigate from a first location (say his/her home) to a second location (say his/her office) using the subject vehicle 104. The user may wish to maintain a distance (or the second safety distance 118) between the subject vehicle 104 and the preceding vehicle 106A traveling in front of the subject vehicle so that: (1) no other vehicle may be able to occupy a gap between the subject vehicle 104 and the preceding vehicle 106A; and (2) a driver of the subject vehicle 104 (or if the subject vehicle 104 is an autonomous vehicle, the computing system of the autonomous vehicle) has a sufficient amount of time (e.g., two-second rule) to react to a sudden action (e.g., abrupt slowing or stopping) of a preceding vehicle (e.g., an overtaking vehicle or the preceding vehicle 106A).

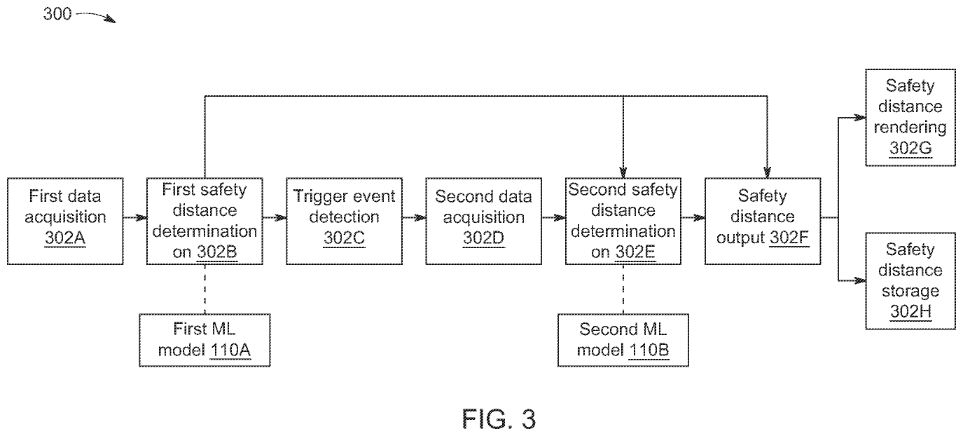

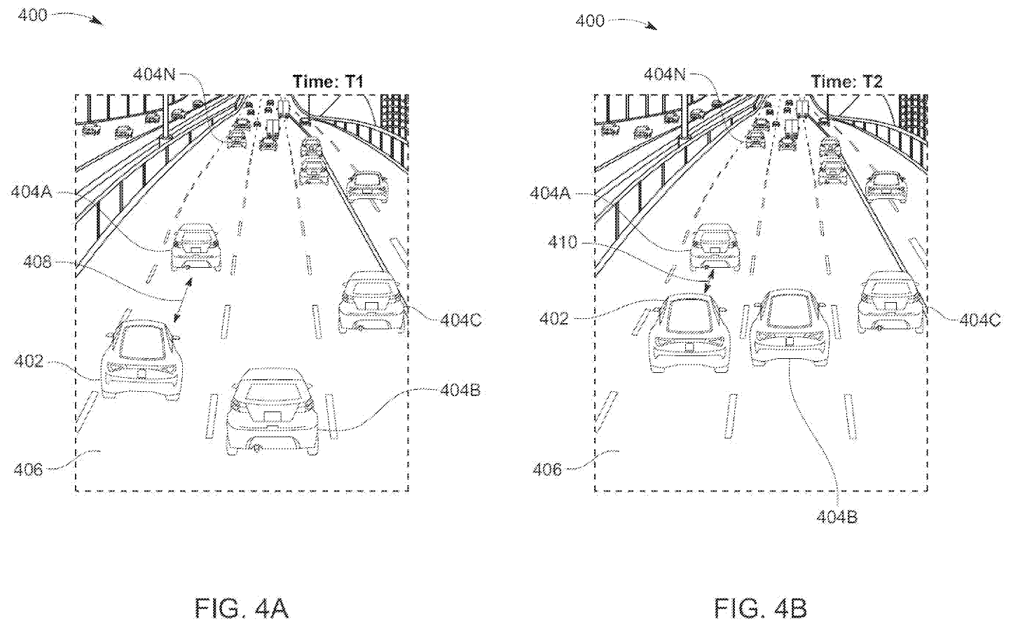

In one embodiment, apparatus 102 may be configured to retrieve (or determine) a first safety distance that may be indicative of a first gap to be maintained between the subject vehicle 104 and the preceding vehicle 106A of the set of vehicles 106. The first safety distance may be indicative of a first gap between the subject vehicle 104 and the preceding vehicle 106A that can be occupied by at least one vehicle of the set of vehicles 106. In an embodiment, the first safety distance may be determined based on an application of the first ML model 110A on a first set of features. The first safety distance may be maintained between the subject vehicle 104 and the preceding vehicle 106A. The first safety distance may be a safety distance to be maintained between the subject vehicle 104 and the preceding vehicle 106A. It is contemplated that, for the first safety distance, another vehicle may be able to occupy the first gap between the subject vehicle 104 and the preceding vehicle 106A. Details about the first set of features and the first safety distance are provided, for example, in FIGS. 3 and 4A.

In a certain scenario, a nearby vehicle (say the first vehicle 106B) may be trying to overtake the subject vehicle 104 and may occupy the first gap between the subject vehicle 104 and the preceding vehicle 106A. The apparatus may detect that the first vehicle 106B is trying to overtake the subject vehicle 104 and may occupy the first gap, thereby rendering potential hazardous situations (such as vehicle-related accidents). Such detection may be based on at least one feature associated with the set of vehicles or a set of users. In order to prevent overtaking and hazardous situations, the apparatus determine may determine and maintain the second safety distance between the subject vehicle 104 and the preceding vehicle 106A.

Apparatus 102 may be configured to obtain a set of features associated with one or more of the set of vehicles 106, one or more of a set of users driving the set of vehicles 106, or a combination thereof while maintaining the retrieved first safety distance from the preceding vehicle 106A. Apparatus 102 may be further configured to determine the second safety distance 118 to be maintained between the subject vehicle 104 and the preceding vehicle 106A based on the retrieved first safety distance and the obtained set of features. In an embodiment, apparatus 102 may be configured to apply the second ML model 110B of the set of ML models 110 on the retrieved first safety distance and the obtained set of features. The first ML model 110A and the second ML model 110B may be pre-trained ML models that may be trained to respectively output the first safety distance and the second safety distance 118 to be maintained between two vehicles such as the subject vehicle 104 and the preceding vehicle 106A. Details about the set of features are provided, for example, in FIG. 3.

The second safety distance 118 may be indicative of a second gap to be maintained between the subject vehicle 104 and the preceding vehicle 106A. The second gap may have to be maintained between the subject vehicle 104 and the preceding vehicle 106A to avoid an occupation of the second gap by at least one vehicle (say the first vehicle 106B) of the set of vehicles 106. In comparison with the first safety distance, the second safety distance 118 may be less than the first safety distance as the first safety distance may be indicative of the first gap that can be occupied by at least one vehicle of the set of vehicles 106, whereas the second safety distance 118 may be maintained between the subject vehicle 104 and the preceding vehicle 106A to avoid the occupation of the second gap by at least one vehicle of the set of vehicles 106. To this end, the determined first safety distance and the second safety distance 118 may be updated in real-time or near real-time, for example, 2 seconds, 5 seconds, 10 seconds, 20 seconds, 30 seconds, and so forth to provide up-to-date traffic data for navigation-related operations.

Apparatus 102 may be configured to output the determined second safety distance 118. In an embodiment, apparatus 102 may be configured to output the second safety distance on the user interface 112A of the infotainment system 112 of the subject vehicle 104. In another embodiment, apparatus 102 may be configured to generate a virtual object that may be indicative of the first safety distance, the second safety distance 118, or a combination thereof and output the generated virtual object on the UI 112A of the infotainment system 112 of the subject vehicle 104. In another embodiment, apparatus 102 may be configured to render an audio output indicative of the first safety distance, the second safety distance 118, or a combination thereof. Details about the output of the second safety distance 118 are provided, for example, in FIGs. FIGS. 3 and 4B.

In some embodiment, once the first vehicle 106B has overtaken the subject vehicle 104 and the preceding vehicle 106A, apparatus 102 may be configured to maintain the first safety distance between the subject vehicle 104 and the preceding vehicle 106A. Therefore, the first safety distance may be the optimum safety distance in case there is no overtaking detected, whereas the second safety distance 118B may be the optimum safety distance in case of the detection of overtaking.

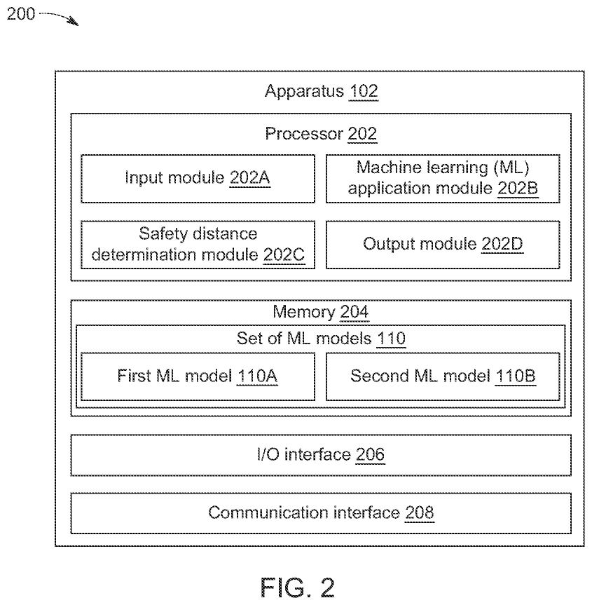

FIG. 2 illustrates a block diagram 200 of the apparatus of FIG. 1, in accordance with an embodiment of the disclosure. FIG. 2 is explained in conjunction with FIG. 1. In FIG. 2, there is shown the block diagram 200 of apparatus 102. Apparatus 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may comprise modules, depicted as, an input module 202A, an ML application module 202B, a safety distance determination module 202C, and an output module 202D. The circuitry 202 may be connected to the memory 204, and the I/O interface 206 through wired or wireless connections. While FIG. 2 illustrates that apparatus 102 includes the processor 202, the memory 204, and the I/O interface 206, apparatus 102 may include fewer or more components to perform the same and/or other functions of apparatus 102. In an embodiment, the input module 202A, and the output module 202D may be integrated within the I/O interface 206. In some embodiments, the input module 202A may receive input data (such as user inputs) and the output module 202B may output processed data (such as the first safety distance, the second safety distance 118, virtual object, and the like) via the I/O interface 206. In an alternative embodiment, the ML application module 202B, the safety distance determination module 202C, and/or contents thereof may be embodied within the memory 204.

In accordance with an embodiment, apparatus 102 may store data that may be generated by the modules while performing corresponding operations or may be retrieved from a database associated with apparatus 102, such as the map database 108B, in the memory 204. For example, the data may include vehicle information, traffic information, user information, distance information, and environmental information.

The processor 202 of apparatus 102 may be configured to determine the first safety distance, determine the second safety distance 118, and output the determined first safety distance and the determined second safety distance 118. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of apparatus 102.

In an example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 206 of apparatus 102. The communication interface 206 may provide an interface for accessing various features and data stored in apparatus 102.

In some embodiments, the processor 202 may be configured to provide Internet-of-Things (IoT) related capabilities to users of apparatus 102 disclosed herein. The IoT-related capabilities may in turn be used to provide smart city solutions by providing real-time safety distance, real-time warnings, big data analysis, and sensor-based data collection by using the cloud-based mapping system for providing accurate navigation instructions and ensuring driver safety. The I/O interface 206 may provide an interface for accessing various features and data stored in apparatus 102.

The input module 202A of the processor 202 may be configured to obtain the first set of features and the second set of features. In an embodiment, the first set of features and the second set of features may be obtained from the one or more sensors. In an example, the one or more sensors may be associated with the subject vehicle 104 and the set of vehicles 106, such as the one or more sensors of the subject vehicle 104, one or more sensors of the set of vehicles 106, or a combination thereof. In another example, the one or more sensors may be installed in the vicinity of link segments of the road 116 to obtain sensor data. For example, the one or more sensors may include one or more image sensors, one or more LIDARs, one or more speed sensors, one or more global positioning sensors (GPS), and the like.

The ML application module 202B of the processor 202 may be configured to apply the first ML model 110A on the obtained first set of features. The ML application module 202B of the processor 202 may be further configured to apply the second ML model 110B on the obtained set of features. The obtained first set of features may be associated with information associated with the subject vehicle 104, vehicle information associated with the one or more of the set of vehicles 106, road information associated with the road 116 on which the subject vehicle 104 and the set of vehicles 106 are being driven, traffic information associated with the road 116, environmental information, distance information associated with a distance between the subject vehicle 104 and a first lane of a set of lanes on the road 116, temporal information, or a combination thereof. The obtained second set of features may be associated with vehicle information associated the one or more of the set of vehicles 106, driving information associated with the one or more of the set of vehicles 106, traffic information associated with the road 116 on which the subject vehicle 104 and the set of vehicles 106 are being driven, user information associated with the one or more of the set of users, temporal information, distance information indicating a distance between two of the set of vehicles 106, or a combination thereof.

The safety distance determination module 202C of the processor 202 may be configured to determine the first safety distance indicative of a first gap to be maintained between the subject vehicle 104 and the preceding vehicle 106A of the set of vehicles 106. The first safety distance may be determined based on an output of the first ML model 110A applied on the obtained first set of features. The safety distance determination module 202C of the processor 202 may be further configured to determine the second safety distance 118 indicative of a second gap to be maintained between the subject vehicle 104 and the preceding vehicle 106A of the set of vehicles 106. The second safety distance 118 may be determined based on an output of the second ML model 110B applied on the obtained set of features.

The output module 202D of the processor 202 may be configured to output the first safety distance, the second safety distance 118, or a combination thereof. In an embodiment, the output module 202D may be configured to generate a virtual object indicating the first safety distance, the second safety distance 118, or a combination thereof. The output module 202D may be further configured to output the generated virtual object on the infotainment system 112 of the subject vehicle 104. In another embodiment, the output module 202D of the processor 202 may be configured to transmit at least one of the first safety distance or the second safety distance 118 to the map database 108B. In another embodiment, the output module 202D of the processor 202 may be configured to control maneuver of the subject vehicle 104 to maintain one of the first safety distance or the second safety distance 118 between the subject vehicle 104 and the preceding vehicle 106A.

The memory 204 of apparatus 102 may be configured to the first set of features, the second set of features, the first safety distance, and the second safety distance 118. The memory 204 of apparatus 102 may be configured to store a first navigation route, a first command, a driving range, a likelihood value, and a virtual object. The memory 204 may be further configured to store a first training sample and a second training sample. In an embodiment, the memory 204 may be configured to store the first ML model 110A, and the second ML model 110B. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling apparatus 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In some example embodiments, the I/O interface 206 may communicate with apparatus 102 and displays the input and/or output of apparatus 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, apparatus 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notifications associated with the navigation instructions, such as traffic data, traffic conditions, traffic congestion value, ETA, routing information, road conditions, driving instructions, etc., on the user equipment or audio or display onboard the vehicles via the I/O interface 206.

The communication interface 208 may comprise input interface and output interface for supporting communications to and from apparatus 102 or any other component with which apparatus 102 may communicate. The communication interface 208 may be any means such as a device or circuitry embodied in either hardware or a combination of hardware and software that is configured to receive and/or transmit data to/from a communications device in communication with apparatus 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB) or other mechanisms. In some embodiments, the communication interface 208 may enable communication with a cloud-based network to enable deep learning, such as using the set of ML models 110 (that may be hosted on the cloud-based network).

FIG. 3 is a diagram 300 that illustrates exemplary operations for determining a safety distance between vehicles, in accordance with an embodiment of the disclosure. FIG. 3 is explained in conjunction with elements from FIG. 1 and FIG. 2. With reference to FIG. 3, there is shown the block diagram 300 that illustrates exemplary operations from 302A to 302H, as described herein. The exemplary operations illustrated in the block diagram 300 may start at 302A and may be performed by any computing system, apparatus, or device, such as by apparatus 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the particular implementation.

In an embodiment, a user of the subject vehicle 104 may be planning to navigate from a first location (say his/her home) to a second location (say his/her office) using the subject vehicle 104. The exemplary operations from 302A to 302H may be executed as soon as an ignition of the subject vehicle 104 may be turned on or the subject vehicle 104 starts moving. In another embodiment, the exemplary operations from 302A to 302H may be executed based on a reception of a user input from the user of the subject vehicle 104 via an input device (say via a button installed in the subject vehicle 104).

At 302A, a first data acquisition operation may be executed. In the first data acquisition operation, apparatus 102 may be configured to obtain a first set of features. Specifically, the input module 202A of the processor 202 may be configured to obtain the first set of features. In an embodiment, apparatus 102 may be configured to obtain the first set of features based on the reception of the user input or the start of the ignition of the subject vehicle 104. In another embodiment, apparatus 102 may be configured to obtain the first set of features automatically without reception of any user input. In an embodiment, the obtained first set of features may be associated with information associated with the subject vehicle 104, vehicle information associated with the one or more of the set of vehicles 106, road information associated with the road 116 on which the subject vehicle 104 and the set of vehicles 106 are being driven, traffic information associated with the road 104, environmental information, distance information associated with a distance between the subject vehicle 104 and a first lane of a set of lanes on the road 116, temporal information, or a combination thereof.

Specifically, the first set of features may include at least one of a class feature, a lane feature, a congestion feature, a flow feature, a time feature, a driving feature, a distance feature, a weather feature, a vehicle feature, a road feature, a neighboring vehicles feature, and an occupancy feature. As discussed above, each of the class feature, the lane feature, the congestion feature, the flow feature, the time feature, the driving feature, the distance feature, the weather feature, the vehicle feature, the road feature, a neighboring vehicles feature, and an occupancy feature may be associated with at least one of the information associated with the subject vehicle 104, the vehicle information, the road information, the traffic information, the environmental information, the distance information, or the temporal information. Details about each of the first set of features are provided below in Table 1:

TABLE 1
First Set of Features with their aliases.

| Feature Name | Alias | Corresponds to |
|---|---|---|
| Class Feature | Functional Class (FC) | Road Information |
| Lane Feature | Number of Lanes | Road Information |
| Congestion | Congestion | Traffic Information/Temporal |
| Feature | | Information |
| Flow Feature | Vehicle Flow | Traffic Information/Temporal |
| | | Information |
| Time Feature | Time of Day | Temporal Information/ |
| | | Environmental Information |
| Driving Feature | Aggressive Driving | Traffic Information |
| | Hotspot | |
| Distance Feature | Distance on the left | Distance Information |
| | Lane | |
| Weather Feature | Weather | Environmental Information |
| Vehicle Feature | Body Destroyed | Information associated with |
| | Vehicle (BDV) | the subject vehicle |
| | | 104/Vehicle Information |
| Road Feature | Road Surface | Road Information |
| Neighboring | Number of Heavy | Information associated with |
| Vehicles Feature | Vehicles in Proximity | the subject vehicle |
| | | 104/Vehicle Information |
| Occupancy | Baby on Board | Information associated with |
| Feature | | the subject vehicle 104 |

The functional class (or the class feature) may be a road type indicator that may reflect a traffic speed and a traffic volume, as well as the importance and connectivity of the road 116. The functional class of the road 116 may be a numerical value ranging from 1 to 5. For example, the functional class “1” may indicate a road with a high-volume traffic, and a maximum-speed traffic. The functional class “2” may indicate a road with a high volume, and a high-speed traffic. The functional class “3” may indicate a road with a high-volume traffic. The functional class “4” may indicate a road with a high-volume traffic at moderate speeds between neighborhoods and the functional class “5” may indicate a road whose volume and traffic flow may be below the level of any other functional class.

The number of lanes (or the lane feature) may be a numerical value that may indicate a number of lanes on the road 116 on which the subject vehicle 104 and the set of vehicles 106 are traveling. The congestion (or the congestion feature) may be a numerical value that may indicate a number of vehicles within a pre-determined distance (say 50 meters) of the subject vehicle 104. The vehicle flow (or the flow feature) may be a numerical value that may indicate a number of vehicles the passing a certain point in a given time period in one or both directions of the road 116. The time of day (or the time feature) may indicate a current timestamp (in hours). The aggressive driving hotspot (or the driving feature) may indicate whether a current location of the subject vehicle 104 may be in an aggressive driving hotspot or not. The aggressive driving hotspot may refer to a specific area where incidents of aggressive driving behaviors may be frequently observed. These aggressive driving behaviors may include speeding, tailgating, sudden lane changes, running red lights, and other aggressive maneuvers that put the safety of other drivers and pedestrians at risk. The distance on the left lane (or the distance feature) may indicate a distance (in centimeters) between the subject vehicle 104 and a left lane of the road 116. The weather (or the weather feature) may indicate weather conditions (such as sunny, rainy, heavy rain, heavy fog, clear, and the like) at the current location of the subject vehicle 104. The body-destroyed vehicle (or the vehicle feature) may indicate whether a body of the subject vehicle 104 or at least one of the set of vehicles 106 is destroyed or not. The road surface (or the road feature) may indicate a smoothness (low, high, or medium) of the road 116. The number of heavy vehicles in proximity (or the neighboring vehicles feature) may indicate a count of heavy vehicles (such as trucks, buses, trailers, and the like) within the pre-determined distance (say 50 meters) of the subject vehicle 104. The baby on board (or the occupancy feature) may indicate whether a baby is traveling in the subject vehicle 104 or not.

In an embodiment, apparatus 102 may be configured to obtain at least one of the first set of features from the map database 108B. For example, apparatus 102 may be configured to receive the functional class (or the class feature), number of lanes (or the lane feature), the congestion (or the congestion feature), the vehicle flow (or the flow feature), the s aggressive driving hotspot (or the driving feature), and the road surface (or the road feature) from the map database 108B. In another embodiment, apparatus 102 may be configured to obtain the time of day (or the time feature) and the weather (or the weather feature) from the map database 108B. In another embodiment, apparatus 102 may be configured to obtain at least one of the first set of features from the one or more sensors (such as an image sensor, a light detection, and ranging (LiDAR) sensor, and the like) installed on the subject vehicle 104, the set of vehicles 106, or on the road 116. By way of example and not limitation, apparatus 102 may be configured to obtain the distance on the left lane (or the distance feature), the body-destroyed vehicle (or the vehicle feature), the number of heavy vehicles in proximity (or the neighboring vehicles feature feature), and the baby on board (or the occupancy feature) from the one or more sensors.

At 302B, a first safety distance determination operation may be executed. In the first safety distance determination operation, apparatus 102 may be configured to determine a first safety distance. Specifically, the safety distance determination module 202C may be configured to determine the first safety distance. The first safety distance may be indicative of a first gap to be maintained between the subject vehicle 104 and the preceding vehicle 106A of the set of vehicles 106. In an embodiment, apparatus 102 may be configured to determine the first safety distance based on the obtained first set of features.

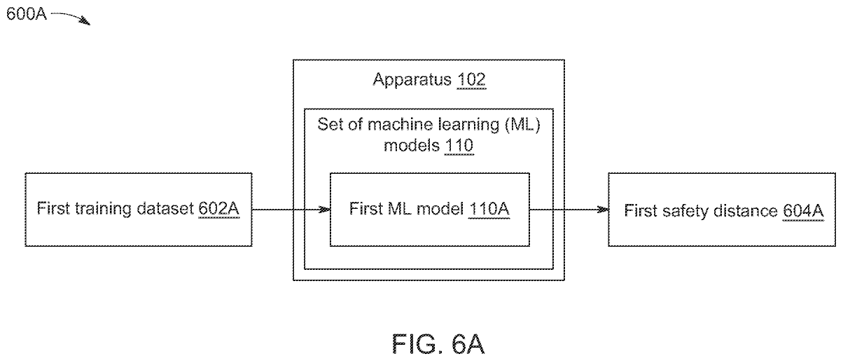

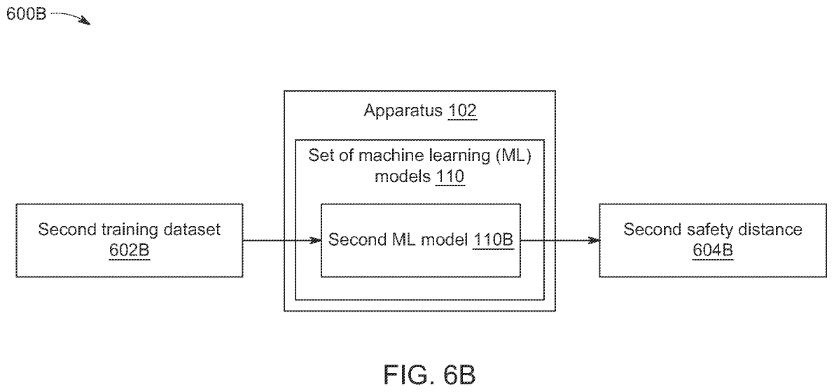

In an alternate embodiment, apparatus 102 may be configured to apply the first ML model 110A of the set of models 110 on the obtained first set of features to determine the first safety distance. Specifically, the ML application module 202B may be configured to apply the first ML model 110A on the obtained first set of features. As discussed above, the first ML model 110A may be a pre-trained machine learning model that may be trained on the first set of features to output the first safety distance. Details about training the first ML model 110A are provided, for example, in FIG. 6A.

Apparatus 102 may be configured to apply the first ML model 110A on the obtained first set of features. Based on the application of the first ML model 110A on the first set of features, apparatus 102 may be configured to determine the first safety distance to be maintained between the subject vehicle 104 and the preceding vehicle 106A of the set of vehicles 106. In an embodiment, the first safety distance may be determined based on an output of the first ML model 110A. The first safety distance may be indicative of the first gap that may be maintained between the subject vehicle 104 and the preceding vehicle 106A to ensure sufficient time and space for braking. The purpose of the first safety distance may be to prevent accidents and to allow for a safer driving experience. Maintaining the first safety distance may be essential for several reasons. Firstly, it may allow for an adequate reaction time in case the preceding vehicle 106A traveling in front of the subject vehicle 104 suddenly stops or there is a hazard on the road 116. Secondly, it may help to reduce the risk of rear-end collisions, ensuring that there is enough space to stop safely without crashing into the preceding vehicle 106A. Another benefit of maintaining the first safety distance may be that it may help to prevent a chain reaction of accidents. If the set of vehicles 106 are too close together and one stops suddenly, it may create a domino effect where multiple vehicles collide. By keeping the first safety distance, the drivers may have more time to react and brake, minimizing the risk of a chain reaction collision. Additionally, maintaining the first safety distance may help to alleviate congestion and improve traffic flow. When the drivers follow the first gap between vehicles, it allows for smoother merging, lane changes, and overall movement on the road 116. This may help to prevent unnecessary traffic jams and may reduce frustration among drivers. Lastly, by keeping the first safety distance, the drivers have a better overall view of the road 116 ahead. This may allow for better anticipation of potential hazards or obstacles, providing more time to take evasive actions or make necessary adjustments to driving behavior. Apparatus 102 may be configured to maintain the determined first safety distance between the subject vehicle 104 and the preceding vehicle 106A.

Despite various advantages of maintaining the first safety distance between the subject vehicle 104 and the preceding vehicle 106A, there may be a scenario where at least the first vehicle 106B of the set of vehicles 106 may overtake the subject vehicle 104 and occupy the maintained first gap, thereby rendering a potentially hazardous situation for the drivers of the subject vehicle 104 and the first vehicle 106B. Therefore, it may be required to anticipate whether the first vehicle 106B may occupy the first gap and reduce the first safety distance to the second safety distance 118 of a second gap between the subject vehicle 104 and the preceding vehicle 106A such that the first vehicle 106B may not be able to fit into the second gap.

At 302C, a trigger event monitoring operation may be executed. In the trigger event monitoring operation, apparatus 102 may be configured to monitor a trigger event while maintaining the first safety distance between the subject vehicle 104 and the preceding vehicle 106A. The trigger event may be indicative of at least one vehicle (say the first vehicle 106B) of the set of vehicles 106 trying to overtake the subject vehicle 104 and possibly occupy the first gap between the subject vehicle 104 and the preceding vehicle 106A of the set of vehicles 106.

In an embodiment, apparatus 102 may be configured to detect a change in a value of at least one feature associated with the set of vehicles 106 or the set of users from a first value to a second value. In an embodiment, the at least one feature may correspond to whether any vehicle of the set of vehicles 106 within the first pre-determined distance of the subject vehicle 104 is changing lanes on the road 116. In another embodiment, the at least one feature may correspond to whether any vehicle of the set of vehicles 106 is driving aggressively (or dangerously) at high speed. In an alternate embodiment, the at least one feature may correspond to whether any vehicle of the set of vehicles 106 within the first pre-determined distance of the subject vehicle 104 is driving at uneven speed. In another embodiment, the at least one feature may correspond to whether at least one driver of the set of drivers driving the set of vehicles 106 is looking at a side or a rear-view mirror.

In one embodiment, apparatus 102 may detect the trigger event in response to detecting a change in the value of at least one feature associated with the set of vehicles 106 or the set of users from a first value to a second different value. As discussed above, the trigger event may be indicative of the first vehicle 106B trying to overtake the subject vehicle 104 and occupy the first gap between the subject vehicle 104 and the preceding vehicle 106A of the set of vehicles 106. Therefore, apparatus 102 may be configured to further reduce the first safety distance to avoid the occupation of the first gap by the first vehicle 106B.

At 302D, a second data acquisition operation may be executed. In the second data acquisition operation, apparatus 102 may be configured to obtain a set of features (also referred to as the second set of features). Specifically, the input module 202A of the processor 202 may be configured to obtain the set of features. In an embodiment, apparatus 102 may be configured to obtain the set of features in response to the detection of the trigger event. The obtained set of features may be associated with at least one of the set of vehicles 106, or the set of users driving the set of vehicles 106. Specifically, the obtained set of features may be associated with at least one of vehicle information associated the one or more of the set of vehicles 106, driving information associated with the one or more of the set of vehicles 106, traffic information associated with the road 116 on which the subject vehicle 104 and the set of vehicles 106 are being driven, user information associated with the one or more of the set of users, temporal information, distance information indicating a distance between two of the set of vehicles 106, or a combination thereof.

Specifically, the set of features may include a lane change feature, an aggressive driving feature, a congestion feature, a flow feature, a time feature, a driver sight feature, a vehicle speed feature, an average distance feature, and a vehicle acceleration feature. As discussed above, each of the aggressive driving feature, the congestion feature, the flow feature, the time feature, the driver sight feature, the vehicle speed feature, the average distance feature, and the vehicle acceleration feature may be associated with at least one of the vehicle information, the driving information, the traffic information, the user information, the temporal information, or the distance information. Details about each of the first set of features are provided below in Table 2:

TABLE 2
Second Set of Features with their Aliases.

| Feature Name | Alias | Corresponds to |
|---|---|---|
| Lane Change | Whether any neighboring | Driving Information |
| Feature | vehicles changing the | |
| | lane? | |
| Aggressive Driving | Whether any neighboring | Driving Information |
| Feature | vehicles driving | |
| | aggressively? | |
| Congestion Feature | Congestion Level | Traffic |
| | | Information/Temporal |
| | | Information |
| Flow Feature | Vehicle Flow | Traffic |
| | | Information/Temporal |
| | | Information |
| Time Feature | Time of Day | Environmental |
| | | Information/Temporal |
| | | Information |
| Driver Sight Feature | Whether driver from a | User Information |
| | neighboring vehicle | |
| | looking at the side or | |
| | rear-view glass? | |
| Vehicle Speed | Whether any neighboring | Driving Information |
| Feature | vehicles driving at | |
| | uneven speeds? | |
| Average Distance | Average distance | Distance Information |
| Feature | between other | |
| | vehicles around | |
| Vehicle | Whether left lane | Driving Information |
| Acceleration Feature | vehicle accelerating? | |

The lane change feature (or whether any neighboring vehicles changing the lane) may indicate whether any vehicle from the set of vehicles 106 is changing its respective lane or not. The aggressive driving feature (or whether any neighboring vehicles driving aggressively) may indicate whether any vehicle from the set of vehicles 106 is driving aggressively (or dangerously) or not. The congestion feature (or the congestion level) may be a numerical value that may indicate a delay (in minutes) associated with the subject vehicle 104. The flow feature (or the vehicle flow) may be a numerical value that may indicate a number of vehicles that may be passing a certain point in a given time period in one or both directions of the road 116. The time feature (or the time of day) may indicate a current timestamp (in hours). The driver sight feature (or whether a driver from a neighboring vehicle looking at the side or rear-view glass) may indicate whether any driver from the set of drivers driving the set of vehicles 106 is looking at the side (or rear-view glass) or not. The vehicle speed feature (or whether any neighboring vehicles driving at uneven speeds) may indicate whether any vehicle from the set of vehicles 106 is driving at uneven speed or not. The average distance feature (or average distance between other vehicles around) may indicate an average distance between the subject vehicle 104 and at least one of the set of vehicles 106. The vehicle acceleration feature (or whether the left lane vehicle accelerating) may indicate whether any vehicle from the set of vehicles 106 that may be driving in the left lane of the road 116 is accelerating and speeding up more than any other vehicle of the set of vehicles 106. Such a vehicle may be less likely to suddenly slow down and more likely to change the lane in front of the subject vehicle 104 and occupy the first gap thereby, annihilating the first safety distance between the subject vehicle 104 and the preceding vehicle 106A.

In an embodiment, apparatus 102 may be configured to obtain at least one of the set of features from the map database 108B. Specifically, apparatus 102 may be configured to transmit a first command to a map database 108B. The first command may be associated with a retrieval of at least one feature of the set of features from the map database 108B. Apparatus 102 may be further configured to obtain at least one feature of the set of features from the map database 108B based on the transmitted first command. For example, apparatus 102 may be configured to receive the congestion feature and the flow feature from the map database 108B. In another embodiment, Apparatus 102 may be configured to obtain the time feature from the map database 108B.

In another embodiment, apparatus 102 may be configured to obtain at least one of the set of features from the one or more sensors (such as the image sensor, the LiDAR sensor, and the like) installed on the subject vehicle 104, the set of vehicles 106, or on the road 116 to obtain at least one of the set of features. Specifically, apparatus 102 may be configured to control one or more sensors associated with at least one of the subject vehicle 104 or at least one vehicle of the set of vehicles 106 to capture sensor data. Apparatus 102 may be further configured to receive the captured sensor data from the one or more sensors. Apparatus 102 may further obtain at least one of the set of features from the received first sensor data. By way of example and not limitation, apparatus 102 may be configured to obtain the lane change feature (or whether any neighboring vehicles changing the lane), the aggressive driving feature (or whether any neighboring vehicles driving aggressively), the driver sight feature (or whether a driver from a neighboring vehicle looking at the side or rear-view glass), the vehicle speed feature (or whether any neighboring vehicles driving at uneven speeds), the average distance feature (or average distance between other vehicles around), and the vehicle acceleration feature (or whether the left lane vehicle accelerating) from the sensor data captured by the one or more sensors.

In an embodiment, apparatus 102 may be configured to calculate a likelihood value indicative of a likelihood of at least one vehicle overtaking the subject vehicle 104 and occupying the first gap between the subject vehicle 104 and the preceding vehicle 106A. The likelihood value may be calculated based on the obtained set of features. Apparatus 102 may be further configured to render the calculated likelihood value on the infotainment system 112 of the subject vehicle 104.

At 302E, a second safety distance determination operation may be executed. In the second safety distance determination operation, apparatus 102 may be configured to determine the second safety distance 118. Specifically, the safety distance determination module 202C may be configured to determine the second safety distance. In an embodiment, apparatus 102 may be configured to determine the second safety distance 118 based on the obtained set of features.

In one embodiment, apparatus 102 may be configured to apply the second ML model 110B of the set of models 110 on the obtained set of features to determine the second safety distance 118. Specifically, the ML application module 202B may be configured to apply the second ML model 110B on the obtained second set of features. As discussed above, the second ML model 110B may be a pre-trained machine learning model that may be trained on the set of features to output the second safety distance 118. Details about training the second ML model 110B are provided, for example, in FIG. 6B.

Apparatus 102 may be configured to apply the second ML model 110B on the obtained set of features. Based on the application of the second ML model 110B on the set of features, apparatus 102 may be configured to determine the second safety distance 118 to be maintained between the subject vehicle 104 and the preceding vehicle 106A of the set of vehicles 106. In an embodiment, the second safety distance 118 may be determined based on an output of the second ML model 110B. The second safety distance 118 may be of a second gap that may have been maintained between the subject vehicle 104 and the preceding vehicle 106A to ensure sufficient time and space for reactions and braking and to further ensure that any other vehicle of the set of vehicles 106 may not be able to occupy the second gap. Therefore, the second safety distance 118 may be less than the first safety distance and may correspond to a safety distance to be maintained between the subject vehicle 104 and the preceding vehicle 106A to prevent occupation of the second gap by at least one vehicle of the set of vehicles 106.

At 302F, a safety distance output operation may be executed. In the safety distance output operation, apparatus 102 may be configured to output the determined second safety distance 118 (and/or the first safety distance). Specifically, the output module 202D may be configured to output the determined second safety distance 118 (and/or the first safety distance). In an embodiment, the output of the second safety distance 118 may correspond to transmission of the second safety distance 118 (and/or the first safety distance) to a cruise control system of the subject vehicle 104 to maintain the second safety distance 118 (and/or the first safety distance) between the subject vehicle 104 and the preceding vehicle 106A. In an embodiment, apparatus 102 may be configured to automatically control maneuver of the subject vehicle 104 to maintain the second safety distance 118 (or the first safety distance) between the subject vehicle 104 and the preceding vehicle 106A.

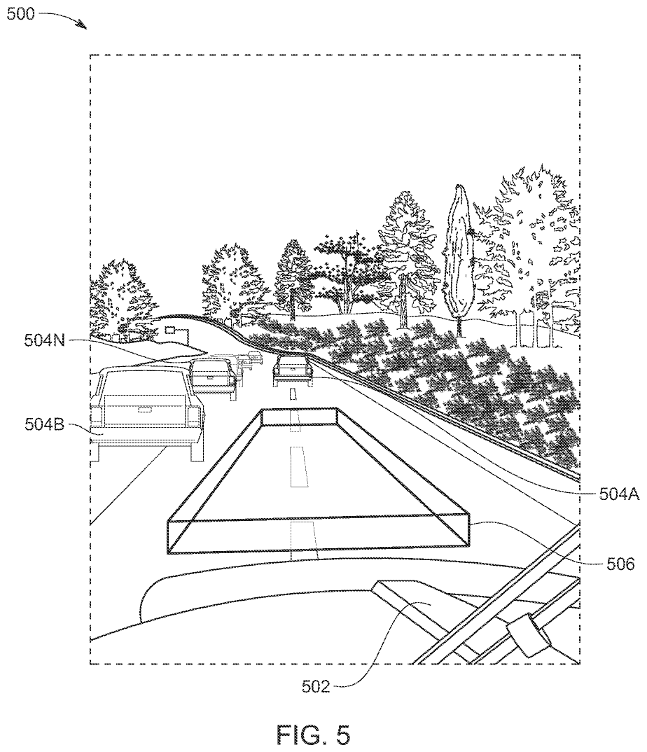

At 302G, a safety distance rendering operation may be executed. In safety distance rendering operation, apparatus 102 may be configured to render the first safety distance and/or second safety distance 118 on the UI 112A of the infotainment system 112 of the subject vehicle 104. In such a scenario, apparatus 102 may be configured to generate a virtual object that may indicate the first safety distance and/or second safety distance 118 to be maintained between the subject vehicle 104 and the preceding vehicle 106A. Apparatus 102 may further render the generated virtual object on the infotainment system 112 or a heads-up display (HUD) of the subject vehicle 104. Details about the virtual object are provided, for example, in FIG. 5.

At 302H, a safety distance storage operation may be executed. In safety distance storage operation, apparatus 102 may be configured to transmit the first safety distance and/or the second safety distance 118 to the map database 108B. This may be useful for determination of a navigation route, and computation of a driving range of an electric vehicle. For example, a user may prefer a navigation route with maximum safety distance between vehicles. Apparatus 102 may receive a user input associated with a determination of the navigation route from a first location to a second location. Apparatus 102 may further determine a set of navigation routes from the first location to the second location based on the received user input. Each navigation route of the set of navigation routes may include at least one of the first safety distance or the second safety distance 118 to be maintained between the subject vehicle 104 and the preceding vehicle 106A. Apparatus 102 may select a first navigation route from the determined set of navigation routes. In the selected first navigation route at least, at least one of the first safety distance or the second safety distance 118 between the subject vehicle 104 and the preceding vehicle 106A may be maximum.

As another example, the subject vehicle 104 may be an electric vehicle. Apparatus 102 may be configured to compute a driving range of the subject vehicle 104 based on at least one of the first safety distance or the second safety distance and output the computed driving range of the subject vehicle 104 on the infotainment system 112 of the subject vehicle 104. In an embodiment, apparatus 102 may compute the driving range while maintaining the first safety distance or the second safety distance. This may ensure that the computed driving range is close to an actual driving range (or accurate driving range) of the electric vehicle while travelling on the road. For example, if a physical area is known, based on data, to have lots of cars coming in between vehicles may lead to a higher battery consumption of the electric vehicle, this data could be used for the modeling of the electric vehicle's driving range computation.

In another embodiment, the output of the safety distance may correspond to the transmission of at least one of the first safety distance or the second safety distance 118 to at least one vehicle of the set of vehicles 106 via vehicle-to-vehicle (V2V) communication. Based on the transmission of at least one of the first safety distance or the second safety distance 118 to at least one vehicle of the set of vehicles 106, the at least one vehicle of the set of vehicles 106 may be informed regarding the at least one of the first safety distance or the second safety distance 118. Based on the reception of the at least one of the first safety distance or the second safety distance 118, each of the set of vehicles 106 may be able to decide whether they should overtake the subject vehicle 104 or not. Apparatus 102 may be further configured to receive at least one notification from at least one vehicle of the set of vehicles 106 based on the transmission of the first safety distance or the second safety distance 118. The received at least one notification may be associated with an overtaking of the subject vehicle 104 by at least one vehicle of the set of vehicles 106. Specifically, the received at least one notification may indicate whether at least one vehicle of the set of vehicle 106 may overtake the subject vehicle in a pre-defined time period or not.

In another embodiment, apparatus 102 may be configured to control maneuver of the subject vehicle 104 to maintain one of the first safety distance or the second safety distance 118 between the subject vehicle 104 and the preceding vehicle 106A. Specifically, apparatus 102 may be configured to control one of an acceleration or a brake of the subject vehicle 104 to maintain one of the first safety distance or the second safety distance 118 between the subject vehicle 104 and the preceding vehicle 106A.

FIGS. 4A and 4B are diagrams that collectively depict an exemplary scenario 400 for dynamic adjustment of a safety distance between vehicles, in accordance with an embodiment of the disclosure. FIGS. 4A and 4B are explained in conjunction with elements from FIGS. 1, 2, and 3. With reference to FIGS. 4A and 4B, there is shown there is shown the exemplary scenario 400 that includes a subject vehicle 402 and a set of vehicles 404 driven on a road 406. The set of vehicles 404 may include a preceding vehicle 404A, a first vehicle 404B, a second vehicle 404C, up to an Nth vehicle 404N. FIG. 4A may represent a scenario at a time “T1”. With reference to FIG. 4A, there is further shown a first safety distance 408 between the subject vehicle 402 and the preceding vehicle 404A of the set of vehicles 404. FIG. 4B may represent a scenario at a time “T2” (after time “T1”).

At time “T1”, apparatus 102 may be configured to obtain the first set of features associated with at least one of the subject vehicle 402 or the set of vehicles 404. Apparatus 102 may be further configured to determine the first safety distance 408 to be maintained between the subject vehicle 402 and the preceding vehicle 404A based on the obtained first set of features. In an embodiment, apparatus 102 may be configured to apply the first ML model 110A of the set of ML models 110 on the obtained first set of features. Apparatus 102 may be further configured to determine the first safety distance 408 indicative of a first gap to be maintained between the subject vehicle 402 and the preceding vehicle 404A based on the output of the first ML model 110A. Apparatus 102 may be further configured to control one of the acceleration or the brake of the subject vehicle 402 to maintain the first safety distance 408 between the subject vehicle 402 and the preceding vehicle 404A.

At time “T1”, a first vehicle 404B of the set of vehicles 404 may be changing the lane or may be driving aggressively or may be driving at uneven speed. In an embodiment, apparatus 102 may be configured to detect that the first vehicle 404B of the set of vehicles 404 may be changing the lane or may be driving aggressively or may be driving at uneven speed. In an embodiment, apparatus 102 may be configured to detect a driver of the first vehicle 404B looking at a side or rear-view glass. Based on the detection of the driver looking at the side or rear-view glass, or the detection of the first vehicle 404B changing the lane or maybe driving aggressively or maybe driving with uneven speed, apparatus 102 may detect the trigger event. Based on the detection of the trigger event, apparatus 102 may be configured to override the first safety distance 408 to determine a second safety distance 410.

Apparatus 102 may be configured to retrieve the first safety distance 408 between the subject vehicle 402 and the preceding vehicle 404A. Apparatus 102 may be further configured to obtain the set of features associated with at least one of the set of vehicles 404, or a set of users driving the set of vehicles 404 based on the retrieved first safety distance 408. Apparatus 102 may be further configured to determine the second safety distance 410 to be maintained between the subject vehicle 402 and the preceding vehicle 404A based on the retrieved first safety distance 408 and the obtained set of features. As depicted, the second safety distance 410 may be less than the first safety distance 408. Apparatus 102 may be further configured to control the maneuver of the subject vehicle 402 to maintain the second safety distance 410 between the subject vehicle 402 and the preceding vehicle 404A.

FIG. 5 is a diagram that illustrates an exemplary scenario 500 for depicting a safety distance between the vehicles, in accordance with an embodiment of the disclosure. FIG. 5 is explained in conjunction with elements from FIGS. 1, 2, 3, 4A, and 4B. With reference to FIG. 5, there is shown there is shown the exemplary scenario 500 that includes a subject vehicle 502 and a set of vehicles 504. The set of vehicles 504 may include a preceding vehicle 504A, a first vehicle 504B, up to an Nth vehicle 504N. With reference to FIG. 5, there is further shown a virtual object 506.

In an embodiment, apparatus 102 may be configured to obtain the first set of features associated with at least one of the subject vehicle 502 or the set of vehicles 504. Apparatus 102 may be further configured to determine the first safety distance to be maintained between the subject vehicle 502 and the preceding vehicle 504A based on the obtained first set of features. In an embodiment, apparatus 102 may be configured to output the determined first safety distance. The output of the first safety distance may correspond to generation of the virtual object 506 indicating the first safety distance to be maintained between the subject vehicle 502 and the preceding vehicle 504A. The virtual object 506 may be a computer-generated representation of an object (or the first gap) that may be overlaid onto a real-world environment. In an embodiment, the virtual object 506 may represent the first gap corresponding to the first safety distance and may be overlaid on a road 508 on which the subject vehicle 502 and the set of vehicles 504 may be driven. In another embodiment, the virtual object 506 may be rendered on the infotainment system 112 of the subject vehicle 104.

In another embodiment, apparatus 102 may be configured to obtain a set of features associated with at least one of the set of vehicles 504, or a set of users driving the set of vehicles 504. Apparatus 102 may be further configured to determine the second safety distance 118 to be maintained between the subject vehicle 502 and the preceding vehicle 504A based on the obtained set of features. In an embodiment, apparatus 102 may be configured to output the determined second safety distance 118. The output of the second safety distance 118 may correspond to the generation of the virtual object 506 which may indicate the second safety distance 118 to be maintained between the subject vehicle 502 and the preceding vehicle 504A. In such instances, the virtual object 506 may represent a second gap corresponding to the second safety distance 118. In an embodiment, the virtual object 506 may be dynamically updated based on the values of at least one of the first safety distance or the second safety distance 118. The virtual object 506, when rendered on the road 508 or on the infotainment system 112 of the subject vehicle 104 may enhance a user experience of the user of the subject vehicle 104. In some embodiments, the virtual object 506 may be rendered on a heads-up display (HUD) of the subject vehicle 104. In some other embodiments, the heads-up display (HUD) may be integrated within a windshield of the subject vehicle 104. In such an embodiment, the virtual object 506 may be rendered on the windshield of the subject vehicle 104.

FIG. 6A is a diagram 600A that illustrates training of the first ML model 110A of the set of machine learning (ML) models 110 for determination of first safety distance between vehicles, in accordance with an embodiment of the disclosure. FIG. 6A is explained in conjunction with elements from FIGS. 1, 2, 3, 4A, 4B, and 5. With reference to FIG. 6A, there is shown the block diagram 600A of apparatus 102 that includes the first ML model 110A. There is further shown a first training dataset 602A, and a first safety distance 604A.

In an embodiment, apparatus 102 may be configured to train the first ML model 110A and the second ML model 110B. The first ML model 110A may be trained on the first training dataset 602A. The first training dataset 602A may include a plurality of training samples and may correspond to a collection of examples that may be used to train the first ML model 110A to make accurate predictions or classifications. The training of the ML model 110A may be an essential component in a machine learning process as it helps the first ML model 110A to learn patterns and relationships within input features (i.e., the set of features).

In an embodiment, apparatus 102 may be configured to receive a first training sample of the plurality of training samples. The first training sample may be indicative of data associated with a past event in which a set of vehicles were within the pre-determined distance of a subject vehicle. The first training sample may further include a first training set of features associated with one or more of information associated with the subject vehicle, vehicle information associated the one or more of the set of vehicles, road information associated with the road on which the subject vehicle and the set of vehicles were driven, traffic information associated with the road, environmental information, distance information associated with a distance between the subject vehicle and a first lane of a set of lanes on the road, the temporal information or a combination thereof. Specifically, the first training sample may include the first training set of features associated with a past event and corresponding to the first set of features obtained when the first ML model 110A is employed for use (e.g., the first data acquisition operation 302A).

In an embodiment, the first training dataset 602A include the first training set of features and a corresponding target label associated with the past event. By way of example and not limitation, a portion of the first training dataset 602A that may have three samples may be represented in Table 3 as follows:

TABLE 3
Portion of First Training Dataset

| | | | | | | Distance | | | | Number | |
|---|---|---|---|---|---|---|---|---|---|---|---|
| Functional | Number | | | Time | Aggressive | on the | | | | of | |
| Class | of | | Vehicle | of | Driving | Left | | | Road | Heavy | |
| (FC) | Lanes | Congestion | Flow | Day | Hotspot | Lane | Weather | BDV | Surface | Vehicles | Distance |
| 1 | 4 | 5 | 12 | 13:00 | No | 40 | Clear | No | Low | 2 | 60 |
| 3 | 2 | 10 | 8 | 12:00 | Yes | 60 | Heavy | No | Medium | 0 | 80 |
| | | | | | | | Rain | | | | |
| 4 | 1 | 5 | 20 | 05:00 | No | 100 | Heavy | No | High | 0 | 20 |
| | | | | | | | Fog | | | | |

As shown in Table 3, the first sample of the first training dataset 602A indicated a distance between a subject vehicle and a preceding vehicle of 60 meters when: (1) a functional class of a road on which the subject vehicle and preceding vehicle were traversing was 1; (2) a number lanes for the road is 4; (3) when a congestion level was 5; (4) a time of day was 13:00; (5) a region in which the subject vehicle was located was not an aggressive driving hotspot; (6) a distance between the subject vehicle and the left lane was 40 centimeters; (7) a weather condition of the region was clear; (8) there was no broken down vehicles in the region; and (9) there was no heavy vehicles within a vicinity of the subject vehicle (e.g., 50 meters). Apparatus 102 may be configured to train the first ML model 110A using the first training dataset 602A to output the first safety distance 604A to be maintained between the subject vehicle 104 and the preceding vehicle 106A in real-life scenarios. Once trained, the first ML model 110A may cause the first ML model 110A to generate output as a function of the first set of features (e.g., the first set of features obtained at the first data acquisition operation 302A). Apparatus 102 may be further configured to determine the first safety distance 604A based at least in part on the output of the first ML model 110A.

In another embodiment, apparatus 102 may be configured to generate a new training sample to be included in the first training dataset 602A. The new training sample may include the obtained first set of features, and the determined first safety distance 604A. Apparatus 102 may be further configured to re-train the first ML model 110A using the generated new training sample. Therefore, the first ML model 110A may be re-trained even when the first ML model 110A is deployed in real-life scenarios.

FIG. 6B is a diagram 600B that illustrates training of the second ML model 110B of the set of machine learning (ML) models 110 for determination of the second safety distance between vehicles, in accordance with an embodiment of the disclosure. FIG. 6B is explained in conjunction with elements from FIGS. 1, 2, 3, 4A, 4B, 5, and 6A. With reference to FIG. 6B, there is shown the block diagram 600B of apparatus 102 that includes the second ML model 110B. There is further shown a second training dataset 602B, and a second safety distance 604B.

Similar to the first training dataset 602A, the second training dataset 602B may include input features and corresponding target labels. In an embodiment, apparatus 102 may be configured to receive a second training sample that may be indicative of data associated with a past event in which one of a set of vehicles within a pre-determined distance of a subject vehicle attempted an overtaking maneuver to occupy a gap between the subject vehicle and a preceding vehicle that was traveling directly ahead of the subject vehicle. The received second training sample may include a second training set of features associated with one or more of the set of vehicles, one or more of a set of users that were driving the set of vehicles, and a distance between the subject vehicle and the preceding vehicle.

In an embodiment, the second training dataset 602A may include the second training set of features and a corresponding target label associated with the past event. By way of example and not limitation, a portion of the second training dataset 602B that may have three samples may be represented in Table 4 as follows:

TABLE 4
Portion of Second Training Dataset

| | | | | | Whether | | | | |
|---|---|---|---|---|---|---|---|---|---|
| | | | | | driver | | | | |
| | | | | | from a | Whether | | | |
| Whether | Whether | | | | neighboring | any | Average | | |
| any | any | | | | vehicle | neighboring | distance | | |
| neighboring | neighboring | | | | looking | vehicles | between | Whether | |
| vehicles | vehicles | | | Time | at the | driving | other | left lane | |
| changing | driving | Congestion | Vehicle | of | rearview | at uneven | vehicles | vehicle | |
| the lane? | aggressively? | Level | Flow | Day | glass? | speeds? | around | accelerating? | Distance |
| Yes | No | 4 | 20 | 8:00 | Yes | No | 5 | Yes | 6 |
| No | No | 10 | 18 | 10:00 | No | Yes | 7 | No | 5 |
| Yes | Yes | 8 | 6 | 13:00 | Yes | Yes | 3 | Yes | 4 |

As shown in Table 4, the first sample of the second training dataset 602B indicated a distance between a subject vehicle and a preceding vehicle of 6 meters when: (1) a neighboring vehicle changed lanes; (2) no neighboring vehicles were driving aggressively; (3) a congestion level of a region in which the subject vehicle was in was level 4; (4) a vehicle flow of a road in which the subject vehicle was traversing was 20 vehicles per minute; (5) a time of day was 8:00; (6) a driver of a neighboring vehicle was looking at a rearview glass; (7) no neighboring vehicles were driving at uneven speeds; (8) an average distance between nearby vehicles was 5 meters; and (9) a vehicle in a lane that was on the left side of the subject vehicle was accelerating. In one embodiment, training samples of the second training dataset 602B indicate past events in which subject vehicles successfully prevented overtaking vehicles from occupying spaces between the subject vehicles and preceding vehicles that were directly traversing ahead of the subject vehicles. Apparatus 102 may be configured to train the second ML model 110B using the second training dataset 602A to output the second safety distance 604B to be maintained between the subject vehicle 104 and the preceding vehicle 106A in real-life scenarios. Once trained, the second ML model 110B may cause the second ML model 110A to generate output as a function of the second set of features (e.g., the second set of features obtained at the second data acquisition operation 302D). Apparatus 102 may be further configured to determine the second safety distance 604B based at least in part on the output of the first ML model 110A.

In another embodiment, apparatus 102 may be configured to generate a new training sample to be included in the second training dataset 602B. The new training sample may include the obtained second set of features, and the determined second safety distance 604B. Apparatus 102 may be further configured to re-train the second ML model 110A using the generated new training sample. Therefore, the second ML model 110A may be re-trained even when the second ML model 110B is deployed in real-life scenarios.

It may be noted that the first training dataset 602A and the second training dataset 602B may be carefully selected and must be representative of a real-world problem of determining the safety distance between vehicles that the first ML model 110A and the second ML model 110B may be designed to solve. The first training dataset 602A and the second training dataset 602B may cover various scenarios and may adequately capture the variability and complexity of the problem of determination of the safety distance between vehicles. In addition, it is important to have a sufficient amount of diverse and well-labeled data in the first training dataset 602A and the second training dataset 602B to train the first ML model 110A and the second ML model 110B effectively.

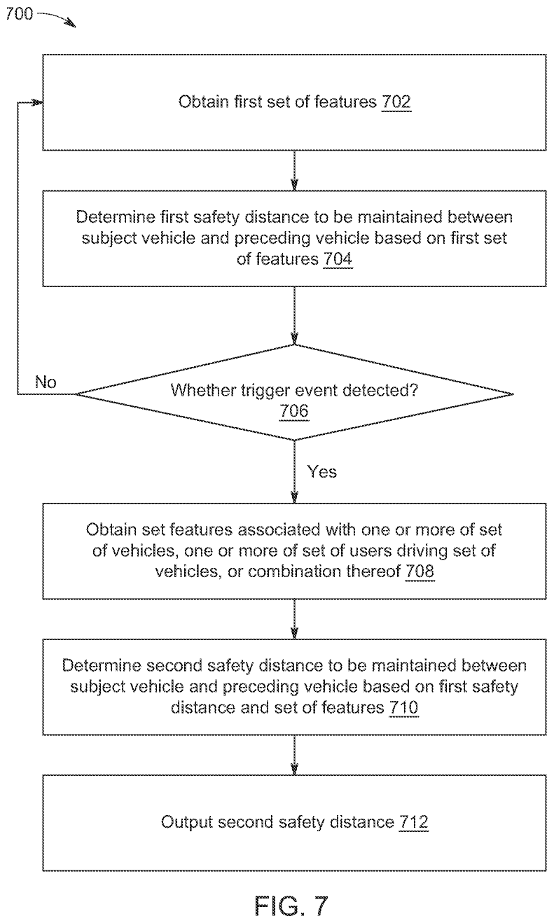

FIG. 7 is a flowchart 700 that illustrates an exemplary method for dynamic determination of safety distance between vehicles, in accordance with an embodiment of the disclosure. FIG. 7 is explained in conjunction with elements from FIGS. 1, 2, 3, 4A, 4B, 5, and 6. With reference to FIG. 7, there is shown a flowchart 700. The operations of the exemplary method may be executed by any computing system, for example, by apparatus 102 of FIG. 1 or the processor 202 of FIG. 2. The operations of the flowchart 700 may start at 702.

At 702, a first set of features may be obtained. In an embodiment, apparatus 102 may be configured to obtain a first set of features that may be associated with information associated with the subject vehicle 104, vehicle information associated with the one or more of the set of vehicles 106, road information associated with the road 116 on which the subject vehicle 104 and the set of vehicles 106 are being driven, traffic information associated with the road 116, environmental information, distance information associated with a distance between the subject vehicle 104 and a first lane of a set of lanes on the road 116, temporal information, or a combination thereof. In at least one embodiment, the processor 202 may be configured to obtain the first set of features, as described, for example, in FIGS. 1 and 3 (at 302A).

At 704, a first safety distance may be determined. In an embodiment, apparatus 102 may be configured to determine the first safety distance 408 to be maintained between the subject vehicle 104 and the preceding vehicle 106A based on the obtained first set of features. In at least one embodiment, the processor 202 may be configured to determine the first safety distance 408 to be maintained between the subject vehicle 104 and the preceding vehicle 106A based on the obtained first set of features, as described, for example, in FIG. 3 (at 302B).

At 706, a trigger event may be detected. In an embodiment, apparatus 102 may be configured to detect a trigger event. The trigger event may be detected based on a change in a value of at least one feature associated with the set of vehicles 106 or the set of users from a first value to a second value. In at least one embodiment, the processor 202 may be configured to detect the trigger event, as described, for example, in FIG. 3 (at 302C). In case the trigger event is detected, the control may pass to 708. Otherwise, the control may pass back to 702.

At 708, a set of features may be obtained. In an embodiment, apparatus 102 may be configured to obtain the set of features associated with one or more of the set of vehicles, one or more of a set of users driving the set of vehicles, or a combination thereof based on the detection of the trigger event. In at least one embodiment, the processor 202 may be configured to obtain the set of features associated with one or more of the set of vehicles, one or more of a set of users driving the set of vehicles, or a combination thereof based on the detection of the trigger event, as described, for example, in FIGS. 1 and 3 (at 302D).

At 710, a second safety distance may be determined. In an embodiment, apparatus 102 may be configured to determine the second safety distance 410 to be maintained between the subject vehicle 104 and the preceding vehicle 106A based on the first safety distance 408 and the obtained set of features. The second safety distance 410 may be less than the first safety distance 408. In at least one embodiment, the processor 202 may be configured to determine a second safety distance 410 to be maintained between the subject vehicle 104 and the preceding vehicle 106A based on the first safety distance 408 and the obtained set of features, wherein the second safety distance 410 may be less than the first safety distance 408. Details about the determination of the second safety distance 410 are provided, for example, in FIGS. 1 and 3 (at 302E).

At 712, the determined second safety distance may be outputted. In an embodiment, apparatus 102 may be configured to output the determined second safety distance 410. The second safety distance 410 may be indicative of a gap to be maintained between the subject vehicle 104 and the preceding vehicle 106A. The second distance is to be maintained between the subject vehicle 104 and the preceding vehicle 106A to avoid an occupation of the gap by at least one vehicle of the set of vehicles 106. In at least one embodiment, the processor 202 may be configured to output the determined second safety distance 410. Details about outputting the second safety distance 410 are provided, for example, in FIGS. 3 (at 302F), 4B, and 5.

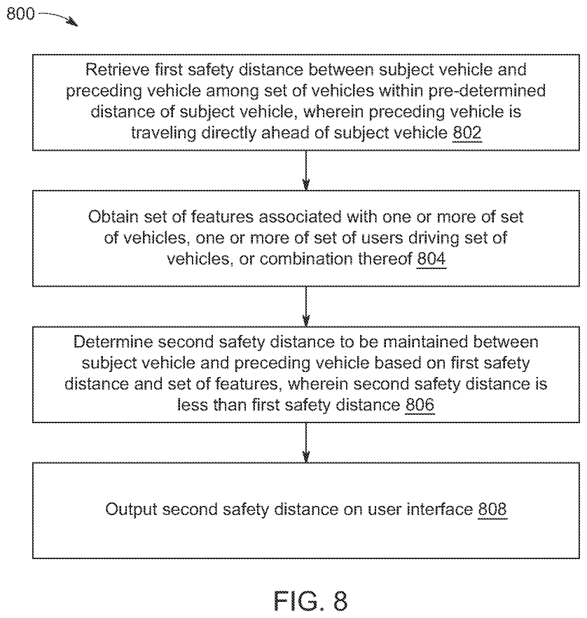

FIG. 8 is a flowchart 800 that illustrates an exemplary method for determination of a second safety distance while maintaining the first safety distance between the vehicles, in accordance with an embodiment of the disclosure. FIG. 8 is explained in conjunction with elements from FIGS. 1, 2, 3, 4A, 4B, 5, 6, and 7. With reference to FIG. 8, there is shown the flowchart 800. The operations of the exemplary method may be executed by any computing system, for example, by apparatus 102 of FIG. 1 or the processor 202 of FIG. 2. The operations of the flowchart 800 may start at 802.

At 802, a first safety distance may be retrieved. In an embodiment, apparatus 102 may be configured to retrieve the first safety distance 408 between the subject vehicle 104 and the preceding vehicle 106A of the set of vehicles 106 within the first pre-determined distance of the subject vehicle 104. The preceding vehicle 106A may be traveling directly ahead of the subject vehicle 104. In an embodiment, apparatus 102 may be configured to retrieve the first safety distance 408 between the subject vehicle 104 and the preceding vehicle 106A of the set of vehicles 106 within the first pre-determined distance of the subject vehicle 104, wherein the preceding vehicle 106A may be traveling directly ahead of the subject vehicle 104. Details about the first safety distance 408 are provided, for example, in FIGS. 1 and 3 (at 302B).

At 804, a set of features may be obtained. In an embodiment, apparatus 102 may be configured to obtain the set of features associated with one or more of the set of vehicles, one or more of a set of users driving the set of vehicles, or a combination thereof. In at least one embodiment, the processor 202 may be configured to obtain the set of features associated with one or more of the set of vehicles 106, one or more of a set of users driving the set of vehicles 106, or a combination thereof based on the retrieved first safety distance 408, as described, for example, in FIGS. 1 and 3 (at 302D).

At 806, a second safety distance may be determined. In an embodiment, apparatus 102 may be configured to determine the second safety distance 410 to be maintained between the subject vehicle 104 and the preceding vehicle 106A based on the retrieved first safety distance 408 and the obtained set of features. In at least one embodiment, the processor 202 may be configured to determine the second safety distance 410 to be maintained between the subject vehicle 104 and the preceding vehicle 106A based on the retrieved first safety distance 408 and the obtained set of features. Details about the determination of the second safety distance 410 are provided, for example, in FIGS. 1 and 3 (at 302E).

At 808, the determined second safety distance may be output. In an embodiment, apparatus 102 may be configured to output the determined second safety distance 410 on the user interface 112A. The second safety distance 410 may be indicative of a second gap to be maintained between the subject vehicle 104 and the preceding vehicle 106A to avoid an occupation of the second gap by at least one vehicle of the set of vehicles 106. In at least one embodiment, the processor 202 may be configured to output the determined second safety distance 410 on the user interface 112A. Details about outputting the second safety distance 410 are provided, for example, in FIGS. 3 (at 302F), 4B, and 5.

Accordingly, blocks of the flowcharts 700 and 800 support combinations of means for performing the specified functions and combinations of operations for performing the specified functions. It will also be understood that one or more blocks of the flowcharts 700 and 800, and combinations of blocks in the flowcharts 700 and 800, can be implemented by special-purpose hardware-based computer systems which perform the specified functions, or combinations of special-purpose hardware and computer instructions.

Alternatively, apparatus 102 may comprise means for performing each of the operations described above. In this regard, according to an example embodiment, examples of means for performing operations may comprise, for example, the processor 202 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. An apparatus comprising at least one processor and at least one non-transitory memory including computer program code instructions, the computer program code instructions configured to, when executed, cause apparatus to:
retrieve a first safety distance between a subject vehicle and a preceding vehicle among a set of vehicles within a pre-determined distance of the subject vehicle, wherein the preceding vehicle is traveling directly ahead of the subject vehicle;
obtain a set of features associated with one or more of the set of vehicles, one or more of a set of users driving the set of vehicles, or a combination thereof;
determine a second safety distance to be maintained between the subject vehicle and the preceding vehicle based on the first safety distance and the set of features, wherein the second safety distance is less than the first safety distance; and
output the second safety distance on a user interface.

2. The apparatus of claim 1, wherein, to determine the second safety distance, the computer program code instructions are configured to, when executed, cause the apparatus to:
monitor a trigger event indicative of a change in a value of at least one feature associated with the set of vehicles or the set of users; and
responsive to detecting the trigger event, determine the second safety distance.

3. The apparatus of claim 1, wherein the set of features is a second set of features, and wherein the computer program code instructions are configured to, when executed, cause the apparatus to:
obtain a first set of features associated with: (i) information associated with the subject vehicle; (ii) vehicle information associated with the one or more of the set of vehicles; (iii) road information associated with a road on which the subject vehicle and the set of vehicles are being driven; (iv) traffic information associated with the road; (v) environmental information; (vi) distance information associated with a distance between the subject vehicle and a first lane of a set of lanes on the road; (vii) temporal information;
or (viii) a combination thereof;
determine the first safety distance to be maintained between the subject vehicle and the preceding vehicle based on the first set of features; and
output the first safety distance on the user interface.

4. The apparatus of claim 3, wherein, to determine the first safety distance, the computer program code instructions are configured to, when executed, cause the apparatus to:
apply a machine learning (ML) model on the first set of features, wherein the ML model is trained to output the first safety distance based on the first set of features; and
determine the first safety distance based on the output of the ML model.

5. The apparatus of claim 1, wherein the set of features is associated with: (i) vehicle information associated with the one or more of the set of vehicles; (ii) driving information associated with the one or more of the set of vehicles; (iii) traffic information associated with a road on which the subject vehicle and the set of vehicles are being driven; (iv) user information associated with the one or more of the set of users; (v) temporal information; (vi) distance information indicating a distance between two vehicles of the set of vehicles; or (vii) a combination thereof.

6. The apparatus of claim 1, wherein, to determine the second safety distance, the computer program code instructions are configured to, when executed, cause the apparatus to:
apply a machine learning (ML) model on the set of features, wherein the ML model is trained to output the second safety distance based on the set of features;
determine the second safety distance based on the output of the ML model, wherein the second safety distance is indicative of a gap to be maintained between the subject vehicle and the preceding vehicle, and wherein the second distance is a distance to be maintained between the subject vehicle and the preceding vehicle to avoid an occupation of the gap by at least one vehicle of the set of vehicles.

7. The apparatus of claim 1, wherein the computer program code instructions are configured to, when executed, cause the apparatus to:
receive a user input associated with a determination of a navigation route from a first location to a second location;
determine, from a map database, a set of navigation routes from the first location to the second location based on the received user input, wherein each navigation route of the set of navigation routes comprises information indicating the first safety distance, the second safety distance, or a combination thereof;
select a first navigation route from the determined set of navigation routes; and
output the selected first navigation route on the user interface.

8. The apparatus of claim 1, wherein, to obtain the set of features, the computer program code instructions are configured to, when executed, cause the apparatus to:
transmit a command to a map database, wherein the command is associated with retrieval of at least one feature of the set of features from the map database; and
obtain the at least one feature of the set of features from the map database.

9. The apparatus of claim 1, wherein, to obtain the set of features, the computer program code instructions are configured to, when executed, cause the apparatus to:
receive sensor data from one or more sensors of the subject vehicle, one or more sensors of the set of vehicles, or a combination thereof; and
obtain at least one of the set of features from the sensor data.

10. The apparatus of claim 1, wherein the subject vehicle is an electric vehicle, and wherein the computer program code instructions are configured to, when executed, cause the apparatus to:
compute a driving range of the subject vehicle based on the first safety distance, the second safety distance, or a combination thereof; and
output the computed driving range of the subject vehicle on the user interface.

11. The apparatus of claim 1, wherein the computer program code instructions are configured to, when executed, cause the apparatus to:
generate a virtual object indicating the first safety distance, the second safety distance, or a combination thereof; and
output the virtual object on an infotainment system of the subject vehicle.

12. The apparatus of claim 1, wherein the computer program code instructions are configured to, when executed, cause the apparatus to:
transmit the first safety distance, the second safety distance, or a combination thereof to the one or more of the set of vehicles; and
receive at least one notification from the one or more of the set of vehicles, wherein the at least one notification is associated with an overtaking of the subject vehicle by the one or more of the set of vehicles.

13. The apparatus of claim 1, wherein the computer program code instructions are configured to, when executed, cause the apparatus to:
calculate a likelihood value indicative of a likelihood of the one or more of the set of vehicles overtaking the subject vehicle and occupying a gap between the subject vehicle and the preceding vehicle; and
output the likelihood value on the user interface.

14. The apparatus of claim 1, wherein the computer program code instructions are configured to, when executed, cause the apparatus to control maneuver of the subject vehicle to maintain the first safety distance or the second safety distance.

15. A method of providing a safety distance between a subject vehicle and a preceding vehicle, the method comprising:
retrieving a first safety distance between the subject vehicle and a preceding vehicle among a set of vehicles within a pre-determined distance of the subject vehicle, wherein the preceding vehicle is traveling directly ahead of the subject vehicle;
obtaining a set of features associated with one or more of the set of vehicles, one or more of a set of users driving the set of vehicles, or a combination thereof;
determining a second safety distance to be maintained between the subject vehicle and the preceding vehicle based on the first safety distance and the set of features, wherein the second safety distance is less than the first safety distance; and
outputting the second safety distance on a user interface.

16. The method of claim 15, further comprising:
applying a first machine learning (ML) model on a first set of features, wherein the first ML model is trained to output the first safety distance based on the first set of features, and wherein the first set of features are associated with: (i) information associated with the subject vehicle; (ii) vehicle information associated with the one or more of the set of vehicles; (iii) road information associated with a road on which the subject vehicle and the set of vehicles are being driven; (iv) traffic information associated with the road; (v) environmental information; (vi) distance information associated with a distance between the subject vehicle and a first lane of a set of lanes on the road; (vii) temporal information; or (viii) a combination thereof; and
determining the first safety distance based on an output of the first ML model.

17. The method of claim 16, wherein the determining the second safety distance comprises:
applying a second machine learning (ML) model on the set of features, wherein the set of features is a second set of features;
determining the second safety distance based on an output of the second ML model, wherein the second safety distance is indicative of a gap to be maintained between the subject vehicle and the preceding vehicle, and wherein the second distance is a distance to be maintained between the subject vehicle and the preceding vehicle to avoid an occupation of the gap by at least one vehicle of the set of vehicles.

18. A non-transitory computer-readable storage medium having computer program code instructions stored therein, the computer program code instructions, when executed by at least one processor, cause the at least one processor to:
retrieve a first safety distance between a subject vehicle and a preceding vehicle among a set of vehicles within a pre-determined distance of the subject vehicle, wherein the preceding vehicle is traveling directly ahead of the subject vehicle;
obtain a set of features associated with one or more of the set of vehicles, one or more of a set of users driving the set of vehicles, or a combination thereof;
determine a second safety distance to be maintained between the subject vehicle and the preceding vehicle based on the first safety distance and the set of features, wherein the second safety distance is less than the first safety distance; and
output the second safety distance on a user interface.

19. The non-transitory computer-readable storage medium of claim 18, wherein the computer program code instructions, when executed by the at least one processor, cause the at least one processor to:
apply a first machine learning (ML) model on a first set of features, wherein the first ML model is trained to output the first safety distance based on the first set of features, and wherein the first set of features are associated with: (i) information associated with the subject vehicle; (ii) vehicle information associated with the one or more of the set of vehicles; (iii) road information associated with a road on which the subject vehicle and the set of vehicles are being driven; (iv) traffic information associated with the road; (v) environmental information; (vi) distance information associated with a distance between the subject vehicle and a first lane of a set of lanes on the road; (vii) temporal information; or (viii) a combination thereof; and
determine the first safety distance based on an output of the first ML model.

20. The non-transitory computer-readable storage medium of claim 19, wherein, to determine the second safety distance, the computer program code instructions, when executed by the at least one processor, cause the at least one processor to:
apply a second machine learning (ML) model on the set of features, wherein the set of features is a second set of features;
determine the second safety distance based on an output of the second ML model, wherein the second safety distance is indicative of a gap to be maintained between the subject vehicle and the preceding vehicle, and wherein the second distance is a distance to be maintained between the subject vehicle and the preceding vehicle to avoid an occupation of the gap by at least one vehicle of the set of vehicles.
